(19) United States
(12) Patent Application Publication
(10) Pub. No.: US 2026/0204065 A1
(43) Pub. Date: Jul. 16, 2026

(54) HAZARD TREE IDENTIFICATION AND PRIORITIZATION OF ELECTRICAL ASSETS, AND ASSOCIATED SYSTEMS, METHODS, AND NON-TRANSITORY COMPUTER-READABLE MEDIA

(71) Applicant: AIDash Inc, Palo Alto, CA (US)

(72) Inventors: Pranav Prakash, Bengaluru (IN); Drew Foster, Canton, MA (US)

(73) Assignee: AIDash Inc, Palo Alto, CA (US)

(21) Appl. No.: 19/452,049

(22) Filed: Jan. 16, 2026

Related U.S. Application Data
(60) Provisional application No. 63/746,182, filed on Jan. 16, 2025.

(51) Int. Cl. G06V 20/10; G06T 7/60; G06V 10/764

(52) U.S. Cl. CPC G06V 20/188; G06T 7/60; G06V 10/764; G06V 20/176

(57) ABSTRACT

An example method includes receiving multiple images for a geographic area that includes multiple electrical assets of a power distribution infrastructure. At least some pixels of each image are classified as hazard tree pixels or as non-hazard tree pixels. Multiple polygons are generated, a polygon corresponding to one or more hazard trees in the geographic area. A height for a particular polygon, a distance from the particular polygon to a particular electrical asset, and one or more obstructions between the particular polygon and the particular electrical asset are determined. Based on those factors, one or more particular hazard trees corresponding to the particular polygon are determined to be a potential hazard to the particular electrical asset. A prioritization of the particular electrical asset is determined. A notification of the prioritization of the particular electrical asset is generated and provided.

### CROSS-REFERENCE TO RELATED APPLICATIONS

This application claims priority to and the benefit of U.S. Provisional Patent Application No. 63/746,182, filed on Jan. 16, 2025, and entitled “HAZARD TREE SEGMENTATION VIA DEEP NEURAL NETWORK MODELS” and is related to U.S. patent application Ser. No. 18/889,308, filed on Sep. 18, 2024, and entitled “SYSTEMS AND METHODS FOR IDENTIFYING HAZARD TREES.” Each of the foregoing applications is incorporated by reference herein in its entirety.

### TECHNICAL FIELD

The present disclosure relates in general to identifying hazard trees, and in particular to identifying hazard trees and determining prioritizations of electrical assets of power distribution infrastructures of electric utilities that may be damaged by hazard trees.

### BACKGROUND

Vegetation management is generally a challenging task for utilities. Over the years, falling and/or encroaching vegetation has led to large-scale power outages, extreme weather events, wildfires, natural disasters, and other vegetation-related hazards. As a result, pressure has increased on utilities, such as electrical power distribution utilities, to improve vegetation management. Manual vegetation management, however, is expensive and may impact system reliability. Further, it is difficult to manually inspect vegetation around electrical assets within a system that extends hundreds to thousands of miles, particularly over inaccessible terrain.

Standard methods of vegetation management include sending utility workers to survey the trees and other vegetation in one particular area within a large geographic area. Utility workers may manually inspect trees and take notes about physical attributes such as tree health, tree height, height profiles at sub-tree levels, and other details. These solutions may be inefficient and time-consuming, particularly in view of the fact that power lines are geographically dispersed. In the U.S. alone, there are millions of miles of local distribution lines, and at least hundreds of thousands of miles of high-voltage transmission lines.

Manual tree inspection is costly, takes time (particularly travel time), and exposes workers to risk. Manual inspections are clearly not scalable. Furthermore, manual inspections may not result in information that can be used to assess the risks of vegetation, such as hazard trees, to electrical assets of an electrical power distribution infrastructure of a utility. A hazard tree may refer to any tree or vegetation that is dead, is unhealthy, or that has structural or other material defects. One example of a hazard tree is a dead tree that may be proximate to an electric line. Another example of a hazard tree is a tree that is declining that may be proximate to an electric line.

A potential risk that hazard trees present is that they may fall into or onto electrical assets such as electrical transmission or distribution lines. Such hazard trees may be the vegetation that is most likely to impact electrical assets. Utility workers may miss such hazard trees, or the utility workers may make inaccurate assessments of parameters of a hazard tree such as tree height, tree crown area, and distance from the hazard tree to an electrical asset. Further, changes over time may be inaccurately estimated, thereby creating or increasing risk before hazard trees can be removed or otherwise controlled.

### SUMMARY

In some aspects, the techniques described herein relate to a non-transitory computer-readable medium including executable instructions, the executable instructions being executable by one or more processors to perform a method, the method including: receiving multiple images for a geographic area, the geographic area including multiple electrical assets of a power distribution infrastructure; classifying, using one or more trained models, at least some pixels of each image of the multiple images as hazard tree pixels or as non-hazard tree pixels; generating, based on at least some of the hazard tree pixels, multiple polygons, a polygon of the multiple polygons corresponding to one or more hazard trees in the geographic area; determining a height for a particular polygon of the multiple polygons; determining a distance from the particular polygon to a particular electrical asset of the multiple electrical assets; determining one or more obstructions between the particular polygon and the particular electrical asset; determining, based on the height, the distance, and the one or more obstructions, that one or more particular hazard trees corresponding to the particular polygon are a potential hazard to the particular electrical asset; determining, based on the one or more particular hazard trees being a potential hazard to the particular electrical asset, a prioritization of the particular electrical asset; generating a notification of the prioritization of the particular electrical asset; and providing the notification of the prioritization of the particular electrical asset.

In some aspects, the techniques described herein relate to a non-transitory computer-readable medium wherein the one or more obstructions include one or more trees or one or more buildings.

In some aspects, the techniques described herein relate to a non-transitory computer-readable medium wherein determining that the one or more particular hazard trees are a potential hazard to the particular electrical asset includes determining that the one or more particular hazard trees are a striking hazard to the particular electrical asset.

In some aspects, the techniques described herein relate to a non-transitory computer-readable medium wherein classifying, using the one or more trained models, at least some pixels of each image of the multiple images as the hazard tree pixels or as the non-hazard tree pixels includes: generating multiple probability data structures by processing the multiple images using the one or more trained models, a probability data structure of the multiple probability data structures corresponding to an image of the multiple images and including, for each pixel of at least some pixels of the image, a probability value that indicates a probability that the pixel is a portion of the one or more hazard trees; and generating multiple classification data structures based on the multiple probability data structures, a classification data structure corresponding to an image of the multiple images and including, for each pixel of at least some pixels of the image, a classification of the pixel as a hazard tree pixel or as a non-hazard tree pixel.

In some aspects, the techniques described herein relate to a non-transitory computer-readable medium wherein generating the multiple classification data structures based on the multiple probability data structures includes, for each probability data structure of at least some of the multiple probability data structures: for each probability value of at least some of the probability values in the probability data structure: comparing the probability value to a threshold value; if the probability value is equal to or greater than the threshold value, classifying the pixel corresponding to the probability value as a hazard tree pixel; and if the probability value is less than the threshold value, classifying the pixel corresponding to the probability value as a non-hazard tree pixel; and generating a classification data structure that includes, for each pixel of at least some pixels of the image, the classification of the pixel as a hazard tree pixel or as a non-hazard tree pixel.

In some aspects, the techniques described herein relate to a non-transitory computer-readable medium wherein a pixel of an image of the multiple images has one or more intensity values, and the method further includes normalizing the one or more intensity values of each pixel of at least some pixels of each image of the multiple images.

In some aspects, the techniques described herein relate to a non-transitory computer-readable medium wherein generating the notification of the prioritization of the particular electrical asset includes generating a user interface that displays the prioritization of the particular electrical asset and providing the notification of the prioritization of the particular electrical asset includes providing the user interface.

In some aspects, the techniques described herein relate to a non-transitory computer-readable medium wherein classifying, using the one or more trained models, at least some pixels of the multiple images as the hazard tree pixels or as the non-hazard tree pixels includes, for each image of the multiple images: generating one or more transformed images by performing one or more transformations on the image; processing, by the one or more trained models, the one or more transformed images to generate one or more intermediate values for each pixel of at least some pixels of the image; and classifying, based on the one or more intermediate values, each pixel of at least some pixels of the image as a hazard tree pixel or as a non-hazard tree pixel.

In some aspects, the techniques described herein relate to a non-transitory computer-readable medium wherein generating the one or more transformed images by performing the one or more transformations on the image includes performing one or more of a rotation of the image, a flip of the image, a resizing of the image, and an addition of noise to the image.

In some aspects, the techniques described herein relate to a non-transitory computer-readable medium wherein classifying, based on the one or more intermediate values, each pixel of at least some pixels of the image as the hazard tree pixel or as the non-hazard tree pixel includes applying a statistical function to the one or more intermediate values of each pixel of at least some pixels of the image.

In some aspects, the techniques described herein relate to a method, including: receiving multiple images for a geographic area, the geographic area including multiple electrical assets of a power distribution infrastructure; classifying, using one or more trained models, at least some pixels of each image of the multiple images as hazard tree pixels or as non-hazard tree pixels; generating, based on at least some of the hazard tree pixels, multiple polygons, a polygon of the multiple polygons corresponding to one or more hazard trees in the geographic area; determining a height for a particular polygon of the multiple polygons; determining a distance from the particular polygon to a particular electrical asset of the multiple electrical assets; determining one or more obstructions between the particular polygon and the particular electrical asset; determining, based on the height, the distance, and the one or more obstructions, that one or more particular hazard trees corresponding to the particular polygon are a potential hazard to the particular electrical asset; determining, based on the one or more particular hazard trees being a potential hazard to the particular electrical asset, a prioritization of the particular electrical asset; generating a notification of the prioritization of the particular electrical asset; and providing the notification of the prioritization of the particular electrical asset.

In some aspects, the techniques described herein relate to a method wherein the one or more obstructions include one or more trees or one or more buildings.

In some aspects, the techniques described herein relate to a method wherein determining that the one or more particular hazard trees are a potential hazard to the particular electrical asset includes determining that the one or more particular hazard trees are a striking hazard to the particular electrical asset.

In some aspects, the techniques described herein relate to a method wherein classifying, using the one or more trained models, at least some pixels of each image of the multiple images as the hazard tree pixels or as the non-hazard tree pixels includes: generating multiple probability data structures by processing the multiple images using the one or more trained models, a probability data structure of the multiple probability data structures corresponding to an image of the multiple images and including, for each pixel of at least some pixels of the image, a probability value that indicates a probability that the pixel is a portion of the one or more hazard trees; and generating multiple classification data structures based on the multiple probability data structures, a classification data structure corresponding to an image of the multiple images and including, for each pixel of at least some pixels of the image, a classification of the pixel as a hazard tree pixel or as a non-hazard tree pixel.

In some aspects, the techniques described herein relate to a method wherein generating the multiple classification data structures based on the multiple probability data structures includes, for each probability data structure of at least some of the multiple probability data structures: for each probability value of at least some of the probability values in the probability data structure: comparing the probability value to a threshold value; if the probability value is equal to or greater than the threshold value, classifying the pixel corresponding to the probability value as a hazard tree pixel; and if the probability value is less than the threshold value, classifying the pixel corresponding to the probability value as a non-hazard tree pixel; and generating a classification data structure that includes, for each pixel of at least some pixels of the image, the classification of the pixel as a hazard tree pixel or as a non-hazard tree pixel.

In some aspects, the techniques described herein relate to a method wherein a pixel of an image of the multiple images has one or more intensity values, and the method further includes normalizing the one or more intensity values of each pixel of at least some pixels of each image of the multiple images.

In some aspects, the techniques described herein relate to a method wherein generating the notification of the prioritization of the particular electrical asset includes generating a user interface that displays the prioritization of the particular electrical asset and providing the notification of the prioritization of the particular electrical asset includes providing the user interface.

In some aspects, the techniques described herein relate to a method wherein classifying, using the one or more trained models, at least some pixels of the multiple images as the hazard tree pixels or as the non-hazard tree pixels includes, for each image of the multiple images: generating one or more transformed images by performing one or more transformations on the image; processing, by the one or more trained models, the one or more transformed images to generate one or more intermediate values for each pixel of at least some pixels of the image; and classifying, based on the one or more intermediate values, each pixel of at least some pixels of the image as a hazard tree pixel or as a non-hazard tree pixel.

In some aspects, the techniques described herein relate to a method wherein generating the one or more transformed images by performing the one or more transformations on the image includes performing one or more of a rotation of the image, a flip of the image, a resizing of the image, and an addition of noise to the image.

In some aspects, the techniques described herein relate to a system including at least one processor and at least one memory including executable instructions that when executed by the at least one processor cause the system to: receive multiple images for a geographic area, the geographic area including multiple electrical assets of a power distribution infrastructure; classify, using one or more trained models, at least some pixels of each image of the multiple images as hazard tree pixels or as non-hazard tree pixels; generate, based on at least some of the hazard tree pixels, multiple polygons, a polygon of the multiple polygons corresponding to one or more hazard trees in the geographic area; determine a height for a particular polygon of the multiple polygons; determine a distance from the particular polygon to a particular electrical asset of the multiple electrical assets; determine one or more obstructions between the particular polygon and the particular electrical asset; determine, based on the height, the distance, and the one or more obstructions, that one or more particular hazard trees corresponding to the particular polygon are a potential hazard to the particular electrical asset; determine, based on the one or more particular hazard trees being a potential hazard to the particular electrical asset, a prioritization of the particular electrical asset; generate a notification of the prioritization of the particular electrical asset; and provide the notification of the prioritization of the particular electrical asset.

### BRIEF DESCRIPTION OF THE DRAWINGS

FIG. 1 depicts an example environment in which the hazard tree identification system may operate in some embodiments.

FIG. 2 depicts a block diagram of the hazard tree identification system in some embodiments.

FIG. 3A depicts a geographic area where electrical assets may be located in some embodiments.

FIG. 3B depicts a zoomed-in portion of the geographic area of FIG. 3A.

FIG. 3C depicts trees at various stages and at various classifications determined by the hazard tree identification system in some embodiments.

FIGS. 4A and 4B depict example software code that may be utilized by the hazard tree identification system in some embodiments.

FIG. 5 is a diagram depicting a method for identifying hazard trees in some embodiments.

FIG. 6 is a diagram depicting another method for identifying hazard trees in some embodiments.

FIG. 7 depicts an image for a geographic area that may be utilized by the hazard tree identification system in some embodiments.

FIG. 8A depicts an example processing block for processing images according to some embodiments.

FIG. 8B depicts an example test-time augmentation framework that the hazard tree identification system may utilize in some embodiments.

FIG. 9A depicts an example model that the hazard tree identification system may utilize for segmentation according to some embodiments.

FIG. 9B depicts an example processing block for a decoder of the example model of FIG. 9A in some embodiments.

FIG. 10 depicts a representation of a classification data structure that the hazard tree identification system may have generated based upon processing the image of FIG. 7 in some embodiments.

FIG. 11 depicts polygons representing hazard trees superimposed on the image of FIG. 7 that may be generated by the hazard tree identification system in some embodiments.

FIG. 12 depicts a table containing hazard trees identified by the hazard tree identification system in some embodiments.

FIGS. 13A-13D depict example user interfaces that the hazard tree identification system may generate and provide in some embodiments.

FIG. 14 is a flow diagram depicting a method for identifying hazard trees in some embodiments.

FIGS. 15A and 15B depict example potential tree fall directions from hazard trees toward electrical wires according to some embodiments.

FIG. 16 depicts a block diagram of an example digital device in some embodiments.

Throughout the drawings, like reference numerals will be understood to refer to like parts, components, and structures.

### DETAILED DESCRIPTION

One problem with manual inspection of electrical assets (e.g., transformers, poles, transmission lines, distribution lines, and/or the like) is the inability of utility personnel to inspect all vegetation that may impact functionality. The problem is compounded when the utility supports a huge amount of territory. Moreover, utility personnel often inspect utilities in poor conditions (for example, cold, heat, rain, snow, or the like). Further, utility personnel may not be sufficiently trained. For these reasons, manual inspection can be inaccurate, missing information, misleading, costly, and take considerable time. Inaccurate information, missing information, and delays can also create unanticipated risks of wildfires and service failure which can lead to widespread damage and loss of life.

Accordingly, it would be advantageous to have scalable systems and methods for identifying hazardous trees and determining whether such trees are potential hazards to utility assets such as transmission lines and distribution lines. It would be further advantageous to be able to classify utility assets according to the risks to the utility assets posed by hazard trees.

Various embodiments of a hazard tree identification system and associated methods and non-transitory computer-readable media as described herein may provide technical solutions to these and other technical problems. The hazard tree identification system may process images of geographic areas that include electrical assets of utilities to identify hazard trees. In some embodiments, the hazard tree identification system may determine heights of hazard trees, distances of the hazard trees to electrical assets, obstructions between the hazard trees and electrical assets, and other attributes of hazard trees. The hazard tree identification system may use this and other information to determine whether or not hazard trees represent potential hazards to the electrical assets. In some embodiments, the hazard tree identification system also determines a prioritization of electrical assets. For example, the hazard tree identification system may determine a prioritization that includes a risk score based on the potential hazards represented by hazard trees.

It will be appreciated that various embodiments of the hazard tree identification system and associated methods and non-transitory computer-readable media correct problems caused by current approaches or technology. For example, current approaches or technologies may result in not identifying certain hazard trees or not appropriately categorizing the risk to electrical assets posed by hazard trees. Moreover, current approaches or technologies may not prioritize electrical assets for vegetation management based on hazard trees that are proximate to the electrical assets or other factors.

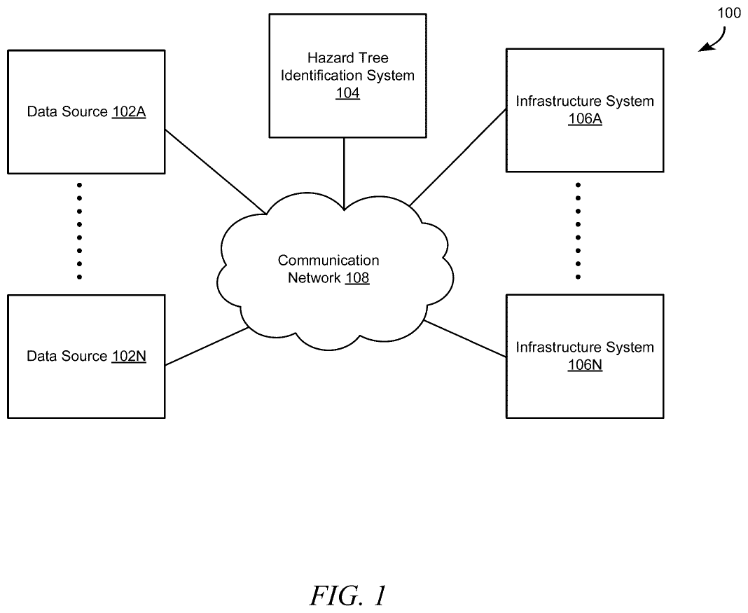

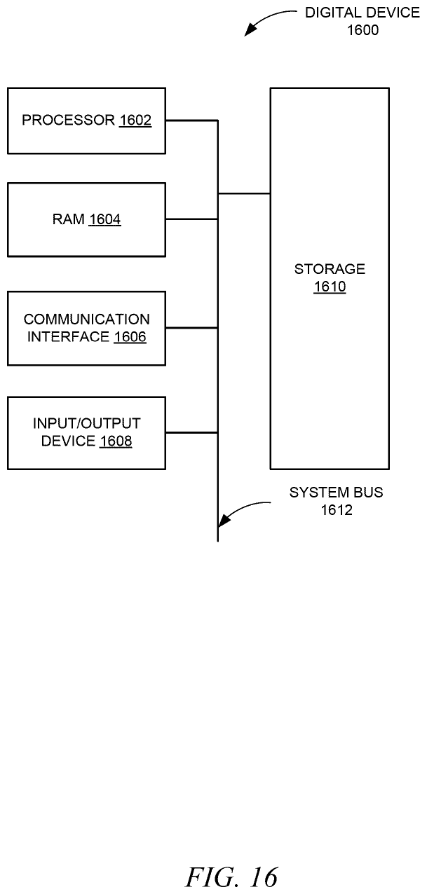

FIG. 1 depicts an example environment 100 in which a hazard tree identification system may operate in some embodiments. The environment 100 includes multiple data sources 102A through 102N (which may be referred to as a data source 102 or as data sources 102), multiple infrastructure systems 106A through 106N (which may be referred to as an infrastructure system 106 or as infrastructure systems 106), a hazard tree identification system 104, and a communication network 108. Each of the data sources 102, the hazard tree identification system 104, and the infrastructure system 106 may be or include any number of digital devices. A digital device is any device with at least one processor and memory. Digital devices are discussed further herein, for example, with reference to FIG. 16.

Data sources 102A to 102N may each be a third party system configured to provide data or access to data. For example, different third parties may periodically capture images, LiDAR data, hyperspectral data, infrared data, ultraviolet data, or other sensor data of geographic areas. For example, some third parties may obtain such data of geographic areas from satellites, airplanes, helicopters, or drones at regular intervals or on-demand for a variety of purposes. Satellite images may be images of geographic areas of the Earth collected by imaging satellites operated by governments and businesses. Different third parties may obtain images from different sources (for example, different satellites, airplanes, helicopters, drones, or the like) for the same or different geographic areas. The third parties may provide images or license access to the images to other businesses for a variety of purposes (for example, via one or more of data sources 102A to 102N). As another example, third parties or infrastructure owners or operators may obtain data from surface modalities that capture surface data from the surface, such as from ground vehicles, sensors attached to infrastructure assets, or sensing devices carried by individuals surveying the infrastructure assets. Such surface data may include images, LiDAR data, hyperspectral data, infrared data, ultraviolet data, or other sensor data (for example, vibration data from sensors attached to electrical utility poles or towers).

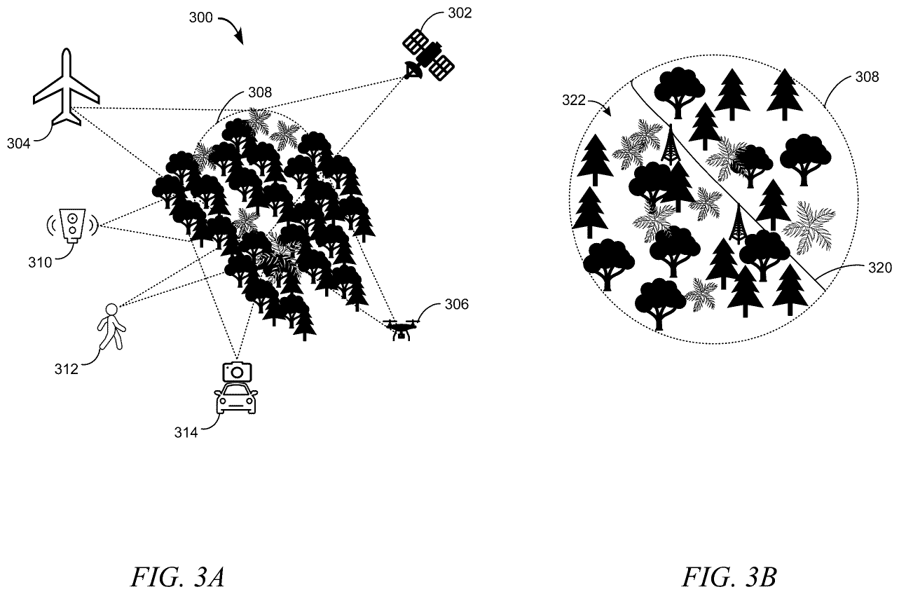

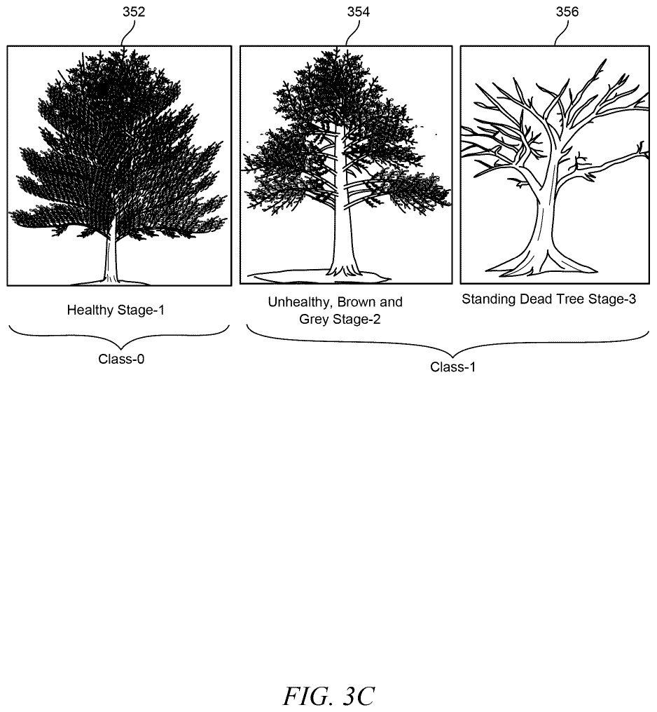

FIG. 3A depicts a geographic area 300 where infrastructure assets, such as electrical assets of an electrical power distribution infrastructure (which may also be referred to as an electrical utility), may be located in some embodiments. Depending upon capabilities and configurations, aerial modalities such as a satellite 302, an aircraft 304, or a drone 306 may capture images, LiDAR data, hyperspectral data, infrared data, ultraviolet data, or other sensor data. Captured data or other information (for example, geographic coordinates and the like) may be stored and provided to others via one or more data sources 102A to 102N. Similarly, depending upon capabilities and configurations, surface modalities such as a LiDAR 310 (for example, mounted to a surface vehicle), a camera or other sensing device carried by an individual 312, or a camera 314 (for example, mounted to a surface vehicle) may capture images, LiDAR data, hyperspectral data, infrared data, ultraviolet data, or other sensor data.

FIG. 3B depicts an example zoomed-in portion 308 of the geographic area 300 of FIG. 3A. The zoomed-in portion 308 depicts that the geographic area 300 includes an electrical asset 320, which includes an electrical powerline, such as a transmission line or a distribution line. The electrical asset 320 may include the towers or poles to which the electrical powerline is attached, or such towers or poles may be considered as separate electrical assets. The geographic area 300 also includes vegetation 322, such as trees. As discussed further herein, the hazard tree identification system 104 may utilize satellite images to detect the vegetation 322 (and other vegetation) that is proximate to the electrical asset 320 (and other electrical assets). The hazard tree identification system 104 may determine vegetation indicators such as vegetation density for portions of the geographic area 300 (and other geographic areas) that include the electrical asset 320 (and other electrical assets).

Returning to FIG. 1, in some embodiments, any number of the data sources 102A to 102N may obtain images of the same geographic area (for example, from satellites, aircraft, or drones) and save them over time. As such, a data source 102 may obtain and store images of the same geographic site taken on different days, months, or years. For example, a data source 102 may provide images at a first duration of time (for example, taken at a particular time and date). The data source 102 may also provide images of the same geographic areas for a second duration (for example, taken at a different particular time or date, such as one or more years before or after the first duration).

Any number of the data sources 102A to 102N may provide application programming interfaces (APIs) to enable another system (for example, the hazard tree identification system 104) to request images for a particular geographic area. The request may be or include a request for current images or for images of the same geographic areas taken at different times. In various embodiments, the hazard tree identification system 104 may request information on what geographic area images are available and at what time frames. A geographic area may be any portion of the Earth. In various embodiments described herein, a geographic area includes assets. For example, electrical assets of a power distribution infrastructure, alternatively referred to as an electrical network infrastructure, may be in a geographic area

The hazard tree identification system 104 may be configured to receive images of any number of geographic areas. The hazard tree identification system 104 may utilize the images and other data for various purposes, to identify hazard trees that may interfere with the safety and operation of assets of a local distribution network or a high-voltage distribution network (which alone or together may be referred to herein as an electrical network). An asset of an electrical network may include, for example, one or more transmission lines, distribution stations, feeder lines, circuit spans, segments, poles, transformers, substations, towers, switches, relays, or the like (which may be referred to herein as electrical assets).

The hazard tree identification system 104 may be described herein as identifying hazard trees. It will be appreciated that the hazard tree identification system 104 may identify any hazardous vegetation, including any number of different types of vegetation (not just trees but also including shrubs, bushes, vines, and/or the like).

In various embodiments, the hazard tree identification system 104 may enhance, orient, and analyze (for example, using artificial intelligence (AI) or machine learning (ML) systems) geographic images to identify trees or vegetation in the images. In some embodiments, the hazard tree identification system 104 may estimate the heights of trees, their crown areas, their volumes, or their densities. The hazard tree identification system 104 may plot the vegetation (such as trees) on maps or provide shapefiles that include information regarding vegetation, such as the location, shape, and attributes of vegetation. Such shapefiles may be utilized in Geographic Information System (GIS) software.

In various embodiments, the hazard tree identification system 104 may request current satellite images from third parties, such as businesses or governments that operate imaging satellites, and utilize the images to identify vegetation. The hazard tree identification system 104 may request other satellite, airplane, helicopter, or drone images for the same geographic areas from the same or different data sources (for example, data sources 102A-102N), combine the images from different data sources for the same geographic areas and then analyze the information to identify potential threats to electrical assets or other information.

Utilizing satellite, airplane, helicopter, or drone images may provide significant advantages. For example, in addition to ease in obtaining the images, it will be appreciated that satellite images may have sufficient spatial resolution (for example, 30 centimeters (cm)×30 cm) for evaluating vegetation such as trees. The spatial resolution may refer to the size of a geographic area on the Earth represented by one pixel of the satellite image. For example, a 30 cm×30 cm spatial resolution may mean each pixel of the satellite image represents a 900 square centimeter area.

Different aerial or satellite images may have different spatial resolutions. In one example, a set of satellite images has a spatial resolution of 50 cm×50 cm. In some embodiments, satellite images have spatial resolutions other than 30 cm×30 cm and 50 cm×50 cm. The hazard tree identification system 104 may utilize satellite or aerial images that have spatial resolutions ranging from approximately 5 cm×5 cm to approximately 1 meter (m)×1 m. The hazard tree identification system 104 may receive images of the same area with different spatial resolutions. The hazard tree identification system 104 may modify certain satellite or aerial images to conform to a standard resolution. In some embodiments, the hazard tree identification system 104 may utilize artificial intelligence (AI) or machine learning (ML) techniques or models to improve the quality of captured images using histogram modification, contrast enhancement, or bilinear interpolation to generate high-resolution images from low-resolution images. For example, the hazard tree identification system 104 may utilize models such as a trained convolutional neural network (CNN) to improve the quality of captured images. Satellite images may be captured using red-green-blue (RGB) bands as well as an infrared (IR) band.

To account for the differences in image capture angles resulting from different forms of image capture, such as satellites, airplanes, helicopters, and drones, the hazard tree identification system 104 may receive images of the same area captured by different image capture methods. In some embodiments, the hazard tree identification system 104 may utilize images from different methods of image capture to correct for different image capture angles, enhance the information contained within the images, and add information for more accurate analysis. The hazard tree identification system 104 may utilize artificial intelligence or machine learning algorithms or models to correct the image capture angles, which may distort objects captured in the images.

In various embodiments, due to environmental factors such as cloud coverage, smoke, or fog, a satellite may require more than one flyover to capture satellite images, or an airplane, helicopter or drone may require more than one pass to capture aerial images of a particular area. The hazard tree identification system 104 may utilize artificial intelligence or machine learning algorithms or models to recognize features on each of the multiple images of the particular area. Similarly, the hazard tree identification system 104 may utilize artificial intelligence or machine learning algorithms or models, such as a CNN, to improve the quality of captured images by using contrast enhancement. In some embodiments, the hazard tree identification system 104 may receive satellite imagery of the same area over several years and use that information to estimate the growth of trees in that area and generate an estimate of a future schedule of vegetation management. Vegetation management may include any activity pertaining to vegetation proximate to utility assets, such as inspection, removal, and pruning.

In various embodiments, the hazard tree identification system 104 may correlate utility equipment or transmission line location information with images captured using various forms of image capture to identify an estimated location of electrical assets (for example, utility equipment or transmission lines). The hazard tree identification system 104 may receive this information from the infrastructure system 106. In one embodiment, the hazard tree identification system 104 may determine the location of transmission lines or utility equipment using feature recognition of an artificial intelligence or machine learning model.

In some embodiments, if the estimated height of vegetation such as a hazard tree is generally greater than or equal to a distance between the tree and an electrical asset, the hazard tree identification system 104 may identify the vegetation as a potential hazard and provide a notification to the infrastructure system 106 of the potentially hazardous vegetation. In some embodiments, the hazard tree identification system 104 may rank the geographic areas contained within a geographic region based on the potentially hazardous vegetation and the facilities served by the infrastructure system 106 (for example, residences, businesses, government and/or public health facilities) that are within the geographic areas. The hazard tree identification system 104 may provide notifications of the ranked geographic areas to the infrastructure system 106.

The infrastructure system 106 may be responsible for the management, control, or alerts regarding a utility infrastructure. A utility infrastructure may be or include any network of infrastructure assets. For example, for an electrical utility, a utility infrastructure may be or include transmission lines, including electrical assets for the generation, transmission, and distribution of electricity. An electrical asset may be or include any component of the electrical network, including, for example, transmission lines, distribution stations, feeder lines, circuit spans, segments, poles, transformers, substations, towers, switches, relays, or the like. In some embodiments, the infrastructure system 106 may be operated by a utility company that owns the utility equipment or transmission lines, such as the Pacific Gas and Electricity Company (PG&E). It will be appreciated that there can be any number of infrastructure systems 106. Although FIG. 1 depicts an infrastructure system 106, it will be appreciated that there may not be an infrastructure system 106 but any system (or any number of different infrastructure systems management by any number of related or unrelated entities) that tracks or enables monitoring of infrastructure assets.

Although electrical networks may be specifically discussed herein, it will be appreciated that embodiments discussed herein may be applied to any infrastructure, including, for example, gas lines, pipelines, buildings, roads, highways, or the like.

In some embodiments, the communication network 108 may represent one or more computer networks (for example, LAN, WAN, or the like). The communication network 108 may provide communication between any of the data sources 102, the hazard tree identification system 104, and any of the infrastructure systems 106. In some implementations, the communication network 108 comprises computer devices, routers, cables, or other network topologies. In some embodiments, the communication network 108 may be wired or wireless. In various embodiments, the communication network 108 may comprise the Internet, one or more networks that may be public, private, IP-based, non-IP based, and so forth.

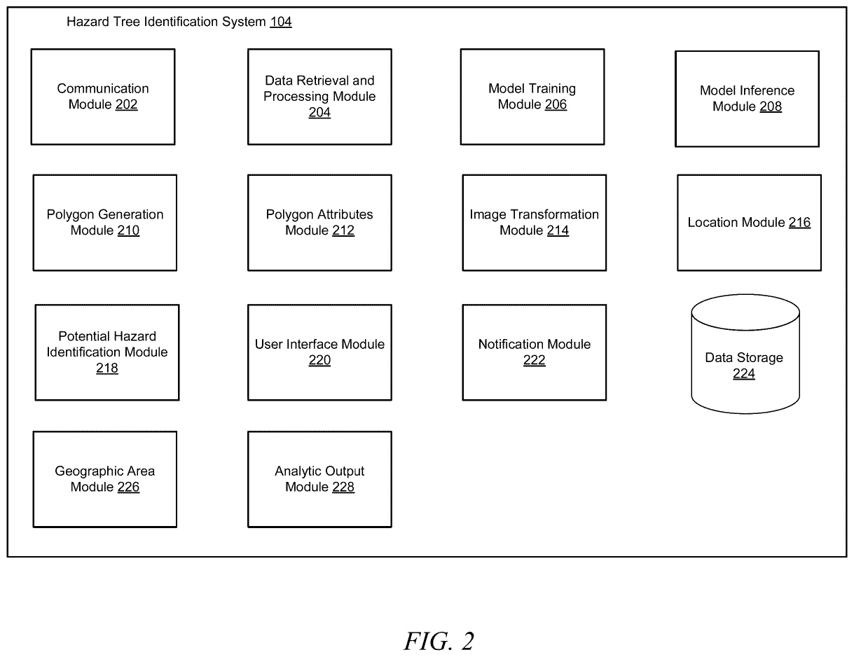

FIG. 2 depicts a block diagram of the hazard tree identification system 104 according to some embodiments. The hazard tree identification system 104 includes a communication module 202, a data retrieval and processing module 204, a model training module 206, a model inference module 208, a polygon generation module 210, a polygon attributes module 212, an image transformation module 214, a location module 216, a potential hazard identification module 218, a user interface module 220, a notification module 222, a data storage 224, a geographic area module 226, and an analytic output module 228.

The communication module 202 may send and receive requests or data between any of the data sources 102, the hazard tree identification system 104, and any of the infrastructure system 106. The communication module 202 may receive a request from a user of the hazard tree identification system 104 (for example, via an interface) to request data from a data source 102. In some embodiments, the communication module 202 may provide an interface or information for a remote interface to enable a third party (for example, a utility, a vegetation management company, workers, supervisors, contractors, insurance companies, or the like) to view and manage vegetation and other management activities relating to infrastructure assets.

In some embodiments, the data retrieval and processing module 204 may retrieve data from any number of data sources 102. In one example, a data source 102 may provide satellite, aerial or ground-level images, video, or other sensed data. The images, video, or other sensed data may be captured by different devices, such as satellites, airplanes, drones, image capture devices, surveillance cameras, and the like. As an example, commercially available satellite images from businesses that operate imaging satellites may provide a user interface or an Application Programming Interface (API) to download satellite images of specific geographic areas that the data retrieval and processing module 204 may utilize to obtain satellite images.

In various embodiments, the data retrieval and processing module 204 may interact with one or more of the data sources 102 to retrieve different images of the same geographic area or different geographic areas. For example, the data retrieval and processing module 204 may retrieve one set of images captured by satellite(s) of a geographic area that is available through one data source 102 and images and LiDAR data captured by an airplane of the same geographic area that is available through another data source 102. In some embodiments, the data retrieval and processing module 204 may request data based on a geographic area (for example, the coordinates of the geographic area), location information, date ranges, quality (for example, high quality or based on resolution), enhancement, orientation, or the like.

In various embodiments, the data retrieval and processing module 204 may utilize an API call to a software system that provides satellite images. In some embodiments, the data retrieval and processing module 204 may receive enhanced and aligned images from a satellite image source. In various embodiments, the data retrieval and processing module 204 may determine if images require enhancement. In some embodiments, the data retrieval and processing module 204 may utilize computer vision techniques and deep learning models to determine if the quality of images may be improved.

In some embodiments, the data retrieval and processing module 204 may optionally scan any number of images, remove noise, remove undesired markings provided by the service, improve accuracy, balance or remove color, or the like. In some embodiments, the spatial resolution of images captured by the different data sources 102 is different. The data retrieval and processing module 204 may utilize techniques such as histogram equalization, contrast enhancement, bilinear interpolation, or some combination thereof to generate high-resolution images from low-resolution images or to standardize image resolutions.

The data retrieval and processing module 204 may also process images to normalize intensity values of pixels of the images to a standard range. The data retrieval and processing module 204 may also process images by calculating various statistical measures of intensity values (for example, 50th percentile or 90th percentile of intensity values).

The model training module 206 may train one or more artificial intelligence (AI) or machine learning (ML) models. In some embodiments, the one or more AI or ML models include encoders and decoders connected in architecture that is at least generally similar to a U-Net architecture. The encoder may utilize a vision transformer as the encoder backbone (for example, DINOv2, DINOv3, or other suitable vision transformer) that is pretrained on a diverse, curated dataset of millions of images, using self-supervised learning (no labels). The vision transformer may produce high-level image features. The decoder may include a dense prediction transformer designed for dense predictions (per-pixel outputs such as segmentation masks, depth, normals). The decoder may upsample feature maps back to image resolution, combine features across scales using skip connections, and produce one or more segmentation masks. The decoder may include multiple layers (for example, five layers) that may be up sampled, for example, using nearest point interpolation. The model training module 206 may also train other models, such as fully convolutional neural networks or sets of decision trees, that may be utilized to select data acquisition modalities for geographic sub-areas of a geographic area.

The model inference module 208 may perform inference on images for a geographic area using the one or more AI or ML models trained by the model training module 206. For example, the model inference module 208 may the one or more AI or ML models to perform segmentation of geographic imagery, that is, to classify pixels of an image as hazard tree pixels or as non-hazard tree pixels to perform inference. The model inference module 208 may also generate data structures as outputs of the inference. The model inference module 208 may also apply other models, such as trained sets of decision trees, to other data, such as satellite images, vegetation indicators derived from satellite images, and requirements data, to select data acquisition modalities for geographic sub-areas of a geographic area.

The polygon generation module 210 may generate polygons that represent or correspond to hazard trees based on hazard tree pixels classified by the model inference module 208. The polygon attributes module 212 may determine metrics for polygons, such as heights, areas, distances to utility assets, and/or other metrics.

The image transformation module 214 may transform images to generate one or more transformed images. For example, the image transformation module 214 may rotate an image to obtain a rotated image. The model inference module 208 may perform inference on such transformed images to obtain values for the pixels of the images. The image transformation module 214 may undo or reverse the effect of the transformation on the values. For example, where the model inference module 208 performed inference on a transformed image that had been rotated 90 degrees clockwise, the image transformation module 214 may rotate the values 90 degrees counterclockwise.

The location module 216 may map polygons to a georeferenced coordinate system. For example, the location module 216 may perform transformations on polygons using an appropriate projection matrix. The location module 216 may also map assets of electrical utilities.

The potential hazard identification module 218 may determine, based on attributes of polygons, such as heights and distances to electrical assets, whether or not the hazard trees corresponding to the polygons represent potential hazards to the electrical assets. In some embodiments, the potential hazard identification module 218 also determines risks posed to electrical assets by such hazard trees. The potential hazard identification module 218 may determine an amount or extent of a risk and/or a classification of the risk.

In some embodiments, the user interface module 220 may generate user interfaces that include geographic areas, infrastructure assets and the data acquisition modalities for the geographic areas. The notification module 222 may generate notifications of availability of analytic outputs or other analysis results. The notification module 222 may also provide notifications to systems such as the infrastructure systems 106.

In some embodiments, the data storage 224 includes data stored, accessed, or modified by any of the modules of the hazard tree identification system 104. The data storage 224 may be or include any data structures, such as tables, lists, databases, or any other structures.

The geographic area module 226 may divide a geographic area (or a portion of a geographic area) into multiple geographic sub-areas. The geographic area module 226 may also locate infrastructure assets in geographic sub-areas. For example, the geographic area module 226 may utilize geographic data such as GIS shapefiles that include data on locations of infrastructure assets. The geographic area module 226 may utilize such geographic data and match features identified in satellite images, aerial images, or other sensed data to the infrastructure assets. The geographic area module 226 may thus georeference infrastructure assets in a common reference space, such as a common coordinate system.

In various embodiments, the analytic output module 228 may generate analytic outputs based on data captured by various data acquisition modalities for geographic areas or for infrastructure assets. The analytic output module 228 may also update analytic outputs when additional data captured by various data acquisition modalities is analyzed. For example, the analytic output module 228 may generate an analytic output for a geographic area based on satellite images captured for that geographic area. The model inference module 208 may select a different data acquisition modality for particular geographic sub-areas of the geographic area. After the hazard tree identification system 104 receives and analyzes data captured by the different data acquisition modality, the analytic output module 228 may generate a new analytic output based on the results of the data analysis or may update the existing analytic output. An analytic output may include a report, a dashboard, a visualization, or other generated content that may express the results of the analysis.

A module of the hazard tree identification system 104 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, or any combination. Software may be executed by one or more processors. Although a limited number of modules are depicted in FIG. 2, there may be any number of modules. Further, individual modules may perform any number of functions, including functions of multiple modules as described herein.

FIG. 3C depicts trees at various stages and at various classifications determined by the hazard tree identification system 104 in some embodiments. In one example, a healthy tree 352 may be at a first stage and the hazard tree identification system may classify at least some pixels of an image (for example, a satellite image or an aerial image) of the healthy tree 352 as zero (0), which may refer to non-hazard tree pixels. A first hazard tree 354, which may be a declining tree, may be at a second stage and a second hazard tree 356, which may be a dead tree, may be at a third stage. In this example, the hazard tree identification system 104 may classify at least some pixels of an image of the first hazard tree 354 and at least some pixels of an image of the second hazard tree 356 as one (1), which may refer to hazard tree pixels. It will be appreciated that the hazard tree identification system 104 may utilize other values (for example, values other than zero (0) or one (1)) for classifications of pixels of images of trees. In some embodiments, images may be associated with values between zero and one.

The hazard tree identification system 104 may utilize one or more artificial intelligence (AI) and/or machine learning (ML) models to identify hazard trees from images, such as satellite images with a 30 cm resolution. For example, the hazard tree identification system 104 may utilize one or more AI or ML models that include encoders and decoders connected in architecture that is at least generally similar to a U-Net architecture. The encoder may utilize a vision transformer as the encoder backbone (for example, DINOv2, DINOv3, or other suitable vision transformer) that is pretrained on a diverse, curated dataset of millions of images, using self-supervised learning (no labels). The vision transformer may produce high-level image features. The decoder may ups-ample feature maps back to image resolution, combine features across scales using skip connections, and produce one or more segmentation masks. The decoder may include multiple layers (for example, five layers) of a convolutional neural network that may be up sampled, for example, using nearest point interpolation. One advantage of using nearest point interpolation is that it may improve reliability for images of a wider range of geographic areas. In some embodiments, the hazard tree identification system 104 may upsample the blocks using transposed convolution.

The hazard tree identification system 104 may utilize one or more generative adversarial networks (GANs) to train the one or more AI or ML models against adversarial noise and to provide improved generalisability for images of a wider range of geographic areas. The hazard tree identification system 104 may improve the one or more GANs using a combination of a Lovasz-Softmax loss and a cross-entropy loss. One advantage of utilizing a Lovasz-Softmax loss is that it is a tractable surrogate for intersection over union (IoU) measure as compared to a dice loss which corresponds to a per-pixel loss. Since the hazard trees may be small in size on images with 30 cm resolution or lower, IoU loss used in this training strategy may allow the hazard tree identification system 104 to ignore noise in the labelled dataset and at the same time provide inferences that may provide higher quality instance segmentation of hazard trees. In some embodiments, the hazard tree identification system 104 may utilize only a Lovasz-Softmax loss. In one example, a function for cross-entropy loss that the hazard tree identification system 104 may utilize is given by equation (1):

$${L}_{C E} ( y , \hat{y} ) = - {\sum }_{i} {ω}_{i} [ {y}_{i} log {\hat{y}}_{i} + ( 1 - {y}_{i} ) log ( 1 - {\hat{y}}_{i} ) ] \qquad ( 1 )$$

In equation (1), ω may be the weights per pixel, yᵢ may be the ground truth pixel values and ŷᵢ may be the model predictions. Other loss functions that may be used for training include Focal Cross Entropy loss (L_{FCE}), which is a cross entropy loss with focus that helps put weight on hard or soft example with a parameter; dice loss (L_{Dice}), Weighted Focal Tversky Loss (L_{WFT}), which may be the standard Tversky loss with the addition of a few parameters. The formulation may be given by equation (1):

$${L}_{W F T} = {( \sum ( {w}_{c} * ( 1 - \frac{\sum ( y * \hat{y} + ϵ )}{( \sum ( 1 - {F}_{β} ) * y + {F}_{β} * \hat{y} + ϵ )} ) ) )}^{γ} \qquad ( 2 )$$

In equation (2), w_{c} is the weight for class c (class 0 is the background and class 1 are the tree polygons), F_{β} is the parameter controlling precision and recall, and γ is the focal parameter. If γ is >1, it gives more weight to examples where loss is high and if γ is <1, it gives more weight to where loss is low. For training the one AI or ML models, the hazard tree identification system 104 may utilize two losses: L₁, one of the L_{CE} Or L_{FCE}; or L₂, one of the dice score based loss: L_{Dice} or L_{WFT}. The total may be given by equation (3):

$${L}_{total} = α * {L}_{1} + ( 1 - α ) * {L}_{2} \qquad ( 3 )$$

The positive and background classes are weighed in the loss function as given by equation (4):

$${W}_{c} = \frac{1}{log ( 1.02 + \frac{{N}_{c}}{{N}_{p}}} \qquad ( 4 )$$

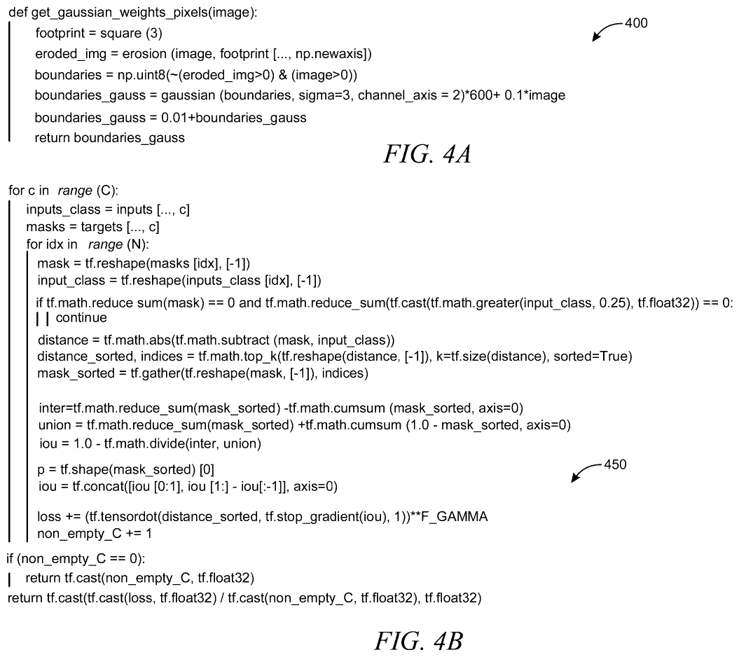

The hazard tree identification system 104 may calculate weights per image to emphasize the edges of the hazard trees that are to be detected via the model. In some embodiments, the hazard tree identification system 104 may calculate the weights by: 1) finding boundaries of polygons using morphological operations to produce another image I and 2) convolving image I with a gaussian kernel which the hazard tree identification system 104 then scales by a constant parameter to produce a weights image W containing weights ωᵢ. FIG. 4A depicts example software code 400 that the hazard tree identification system 104 may utilize to calculate the weights ωᵢ in various embodiments. FIG. 4B depicts example software code 450 that the hazard tree identification system 104 may utilize in calculating a Lovasz-Softmax loss in various embodiments.

In some embodiments, the hazard tree identification system 104 may utilize only a cross-entropy loss. In various embodiments, the hazard tree identification system 104 may, additionally or alternatively, utilize other loss functions.

The hazard tree identification system 104 may evaluate the one or more AI or ML models using the following metrics: Dice coefficient: This metric helps evaluating the performance of segmentation. However, when objects of small size are involved, it does not reliably tell the performance of the one or more AI or ML models when detection of the instances of the objects are relevant. Precision and Recall: The hazard tree identification system 104 may calculate the precision and recall number after generating the instances of the unhealthy tree and generating a list of polygons. Since the object sizes are small, even minor shifts in prediction can massively reduce the overlap between predictions and ground truth. A 10% overlap may be utilized as a true positive.

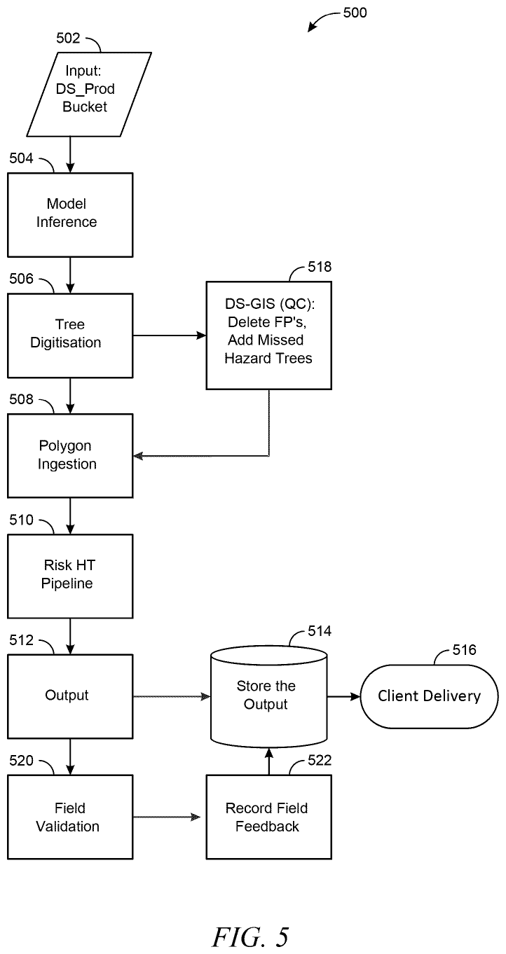

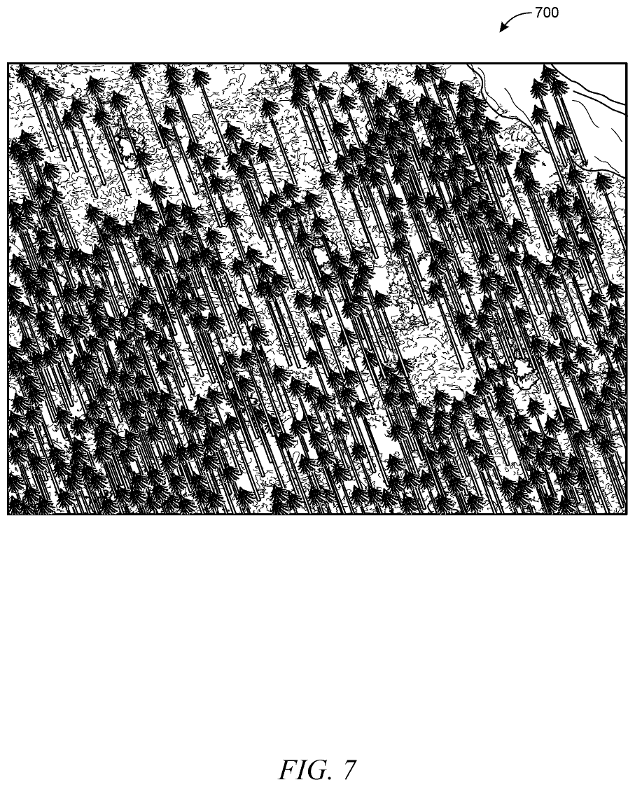

FIG. 5 is a diagram depicting a method 500 for identifying hazard trees in some embodiments. The hazard tree identification system 104 (for example, various modules of the hazard tree identification system 104) may perform the method 500. The method 500 may begin at step 502 where the hazard tree identification system 104 (for example, the data retrieval and processing module 204) receives images for a geographic area. FIG. 7 depicts an example image 700 for a geographic area that may be utilized by the hazard tree identification system 104 in some embodiments. The image 700 includes multiple trees, some of which may be hazard trees. The hazard trees may have characteristics of being dead or unhealthy, such as missing foliage, browned or greyed foliage, greyed limbs or trunks, and/or the like. Such characteristics may be visible, by virtue of their color and/or texture, in images like the image 700.

In some embodiments, the images are images captured by one or more satellites and are georeferenced. Such images may be referred to herein as georeferenced satellite images. A georeferenced satellite image, which may be in the form of a rectangle, may include the coordinates of the top-left vertex and the bottom-right vertex of the rectangle and have a resolution, such as a 30 cm×30 cm spatial resolution. Accordingly, the coordinates of each pixel in the georeferenced satellite image may be determined using the vertex coordinates and the resolution of the georeferenced satellite images.

The georeferenced satellite images may be mono, where a satellite captures one image of a particular area. Alternatively, the georeferenced satellite images may be stereo, where the satellite captures two images of a particular area from two different angles at approximately the same time. The geographic area may include multiple electrical assets of a power distribution infrastructure, such as transmission towers, utility poles, and transmission or distribution lines between utility poles and/or transmission towers (which may be referred to herein as a span).

Returning to FIG. 5, in some embodiments, after receiving the images, the hazard tree identification system 104 (for example, the data retrieval and processing module 204) may process the images for the geographic area. For example, an image may include multiple channels, such as a red channel, a green channel, and a blue channel. Each pixel of the image may have an intensity value for each of the multiple channels. The intensity values may range from zero (0) to 255 or from zero (0) to another value (for example, 4,096) for each channel. The hazard tree identification system 104 may normalize the intensity values of pixels of the image so that, for each pixel, the pixel has an intensity value for each channel of the multiple channels that ranges between zero (0) and one (1).

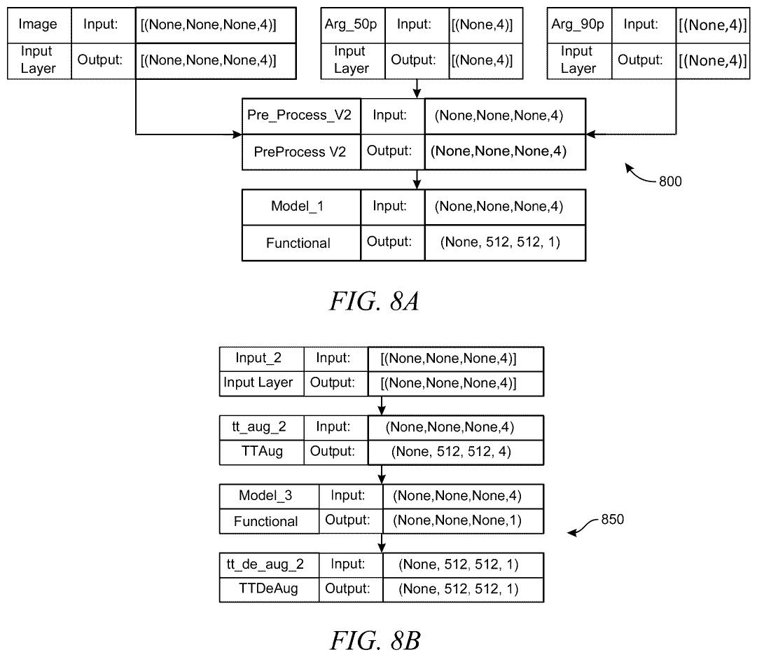

In some embodiments, the hazard tree identification system 104 may process the images for a geographic area by calculating a 50th percentile of intensity values and a 90th percentile of intensity values. The hazard tree identification system 104 may use the 50th percentile of intensity values and the 90th percentile of intensity values that the hazard tree identification system 104 had previously calculated for the multiple images. FIG. 8A depicts an example processing block 800 for processing images according to some embodiments. In the processing block 800 the hazard tree identification system 104 utilizes the 50th percentile of intensity values and the 90th percentile of intensity values. In some embodiments, the processing block 800 may include a TensorFlow optimized layer to batch process images. The hazard tree identification system 104 may have stored the 50th percentile of intensity values and the 90th percentile of intensity values in the data storage 224 and retrieve them from the data storage 224. The hazard tree identification system 104 may process images in other ways, such as by resizing the images, cropping the images, modifying the resolution of images, and/or other ways.

Returning to FIG. 5, at step 504, the hazard tree identification system 104 (for example, the model inference module 208) may perform inference on the images for the geographic area. In some embodiments, the hazard tree identification system 104 classifies, using one or more trained AI and/or ML models (for example, using one or more convolutional neural networks and/or one or more fully convolutional neural networks) the pixels of each image of the multiple images as hazard tree pixels or non-hazard tree pixels.

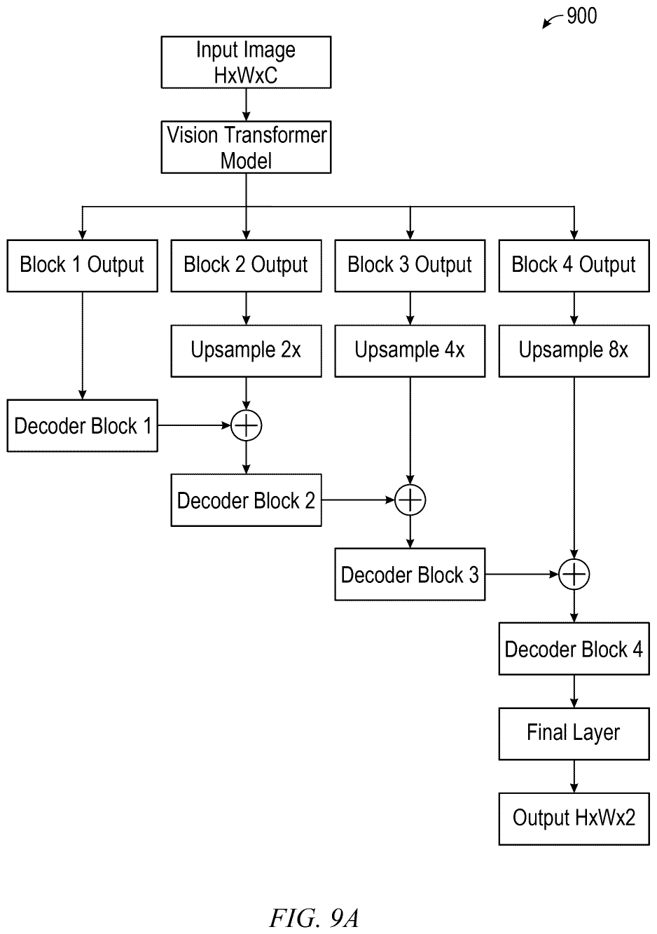

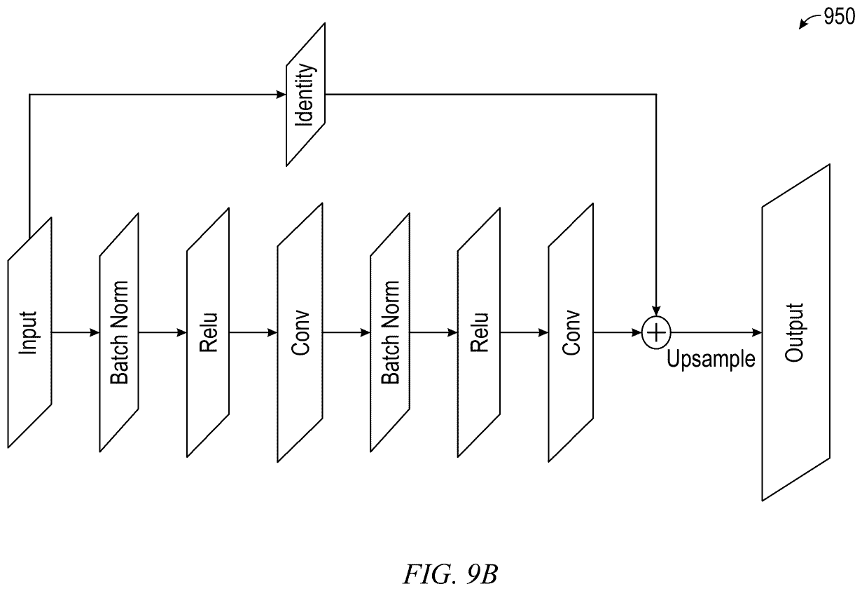

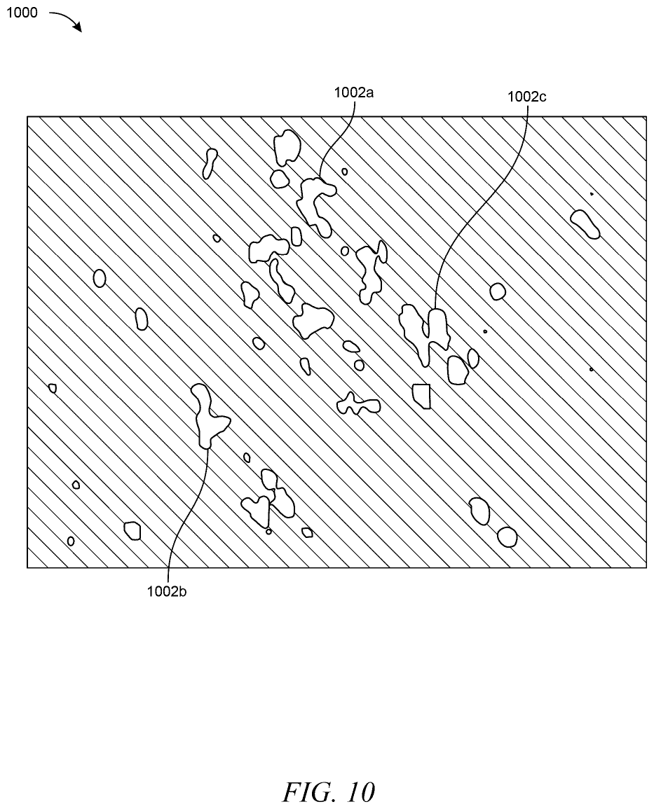

FIG. 9A depicts an example model 900 that the hazard tree identification system 104 may utilize for segmentation according to some embodiments. The model includes encoders and decoders connected in an architecture that is at least generally similar to a U-Net architecture with skip connections coming from successive levels of the encoders to the decoders. The output from different layers of the blocks are used in the decoder layers. In some embodiments, decoders are made of ResNet convolutional blocks followed by an upsampling layer. Each block may be made up of a batch norm and a ReLU followed by a convolutional layer. In some embodiments, the decoders are transformer-based decoders that are specialized for pixel-wise tasks. FIG. 9B depicts an example processing block 950 for a decoder of the example model of FIG. 9A in some embodiments.

In some embodiments, the hazard tree identification system 104 utilizes a test-time augmentation framework to classify pixels of images. FIG. 8B depicts an example test-time augmentation framework 850 that the hazard tree identification system 104 may utilize in some embodiments. The test-time augmentation framework may include an augmentation layer, one or more trained AI and/or ML models (for example, the encoder and decoder layers of the model 900 of FIG. 9A), and a de-augmentation layer. Test-time augmentation may allow for capturing the output of the one or more trained AI and/or ML models under different conditions. In some embodiments, the hazard tree identification system 104 (for example, the image transformation module 214) performs test-time augmentation on an image by performing one or more transformations on the image to generate one or more transformed images, which may be referred to as augmentation. The one or more transformations of the image that the hazard tree identification system 104 may perform on the image may include one or more rotations of the image (for example, 90 degrees clockwise, 90 degrees counter-clockwise, or 180 degrees), one or more flips of the image (for example, about the horizontal axis of the image or about the vertical axis of the image), one or more of resizing the image (for example, to a smaller size and/or a larger size). The hazard tree identification system 104 may de-augment and average the output to obtain the final output. After applying the threshold, the hazard tree identification system 104 may apply binary opening morphological operations to remove noisy pixels. The hazard tree identification system 104 may then digitize the binary map and store the digitized binary map.

The hazard tree identification system 104 (for example, the model inference module 208) may then process the one or more transformed images and the image using the one or more trained AI and/or ML models to generate one or more first intermediate values for each pixel of the image. The hazard tree identification system 104 (for example, the image transformation module 214) may then modify the one or more first intermediate values so as to undo the effect of the one or more transformations on the image, thereby obtaining one or more second intermediate values. For example, where the hazard tree identification system 104 has rotated an image 90 degrees clockwise, the hazard tree identification system 104 may rotate the second intermediate values 90 degrees counterclockwise. The hazard tree identification system 104 undoing the effect of the one or more transformations may be referred to as de-augmentation. The hazard tree identification system 104 may then apply a statistical function on the one or more second intermediate values to obtain third intermediate values. For example, the hazard tree identification system 104 may average the one or more second intermediate values to obtain the third intermediate values. The hazard tree identification system 104 may then classify each pixel of the image based on the third intermediate values as either a hazard tree pixel or as a non-hazard tree pixel.

One output of the hazard tree identification system 104 classifying pixels of an image using one or more trained AI and/or ML models may include a probability data structure that has dimensions that are sized the same as the dimensions of the image. For example, the probability data structure may have the same number of rows as the width of the image in pixels and the same number of columns as the height of the image in pixels. The probability data structure may include, for each pixel of the image, a probability value that indicates a probability that the pixel is of a portion of a hazard tree. In some embodiments, the probability value may be between zero (0) and one (1). The hazard tree identification system 104 may generate multiple probability data structures by processing the multiple images using the one or more trained AI and/or ML models.

In some embodiments, the hazard tree identification system 104 (for example, the model inference module 208) may generate multiple classification data structures based on the multiple probability data structures. A classification data structure may have dimensions that are sized the same as the dimensions of the image (for example, the classification data structure may have the same number of rows as the width of the image in pixels and the same number of columns as the height of the image in pixels). The hazard tree identification system 104 may generate a classification data structure by iterating through a probability data structure and comparing each probability value to a threshold value (for example, 0.5). If the hazard tree identification system 104 determines that the probability value is equal to or greater than the threshold value, the hazard tree identification system 104 may classify the pixel corresponding to the probability value as a hazard tree pixel. If the hazard tree identification system 104 determines that the probability value is less than the threshold value, the hazard tree identification system 104 may classify the pixel corresponding to the probability value as a non-hazard tree pixel. The hazard tree identification system 104 may generate a classification data structure that includes, for each pixel of the image, the classification of the pixel as a hazard tree pixel or as a non-hazard tree pixel. The hazard tree identification system 104 may generate a classification data structure for each image of the multiple images, thereby generating multiple classification data structures.

FIG. 10 depicts a representation 1000 of a classification data structure that the hazard tree identification system 104 may have generated based upon processing the image 700 of FIG. 7. The hazard tree identification system 104 may have generated a probability data structure by processing the image 700 using the one or more trained AI and/or ML models. The hazard tree identification system 104 may have generated the classification data structure based upon the probability data structure. The classification data structure corresponds to the image 700 and may include, for each pixel of the image 700, a classification of the pixel as a hazard tree pixel or as a non-hazard tree pixel. The representation 1000 includes multiple collections of hazard tree pixels, such as a first collection 1002a, a second collection 1002b, and a third collection 1002c. Each collection 1002 corresponds to one or more hazard trees in the image 700.

Returning to FIG. 5, the hazard tree identification system 104 may, at step 506, digitize hazard trees using the hazard tree pixels classified in step 504. For example, the hazard tree identification system 104 (for example, the polygon generation module 210) may generate multiple polygons based on the hazard tree pixels, where a polygon corresponds to one or more hazard trees in an image. For a polygon, the hazard tree identification system 104 may identify or determine a set of coordinates that define the polygon. In some embodiments, the hazard tree identification system 104 may utilize morphological operations to find boundaries of a polygon. For example, the hazard tree identification system 104 may remove noisy pixels using morphological operations, which may reduce false positives. U.S. patent application Ser. No. 18/167,830, filed Feb. 10, 2023 and entitled SYSTEMS AND METHODS FOR IDENTIFYING TREES AND ESTIMATING TREE HEIGHTS AND OTHER TREE PARAMETERS, describes techniques for digitizing trees and is incorporated in its entirety by reference herein. The hazard tree identification system 104 (for example, the location module 216) may map the polygons to a georeferenced coordinate system by transforming the geometry of the polygons with an appropriate projection matrix.

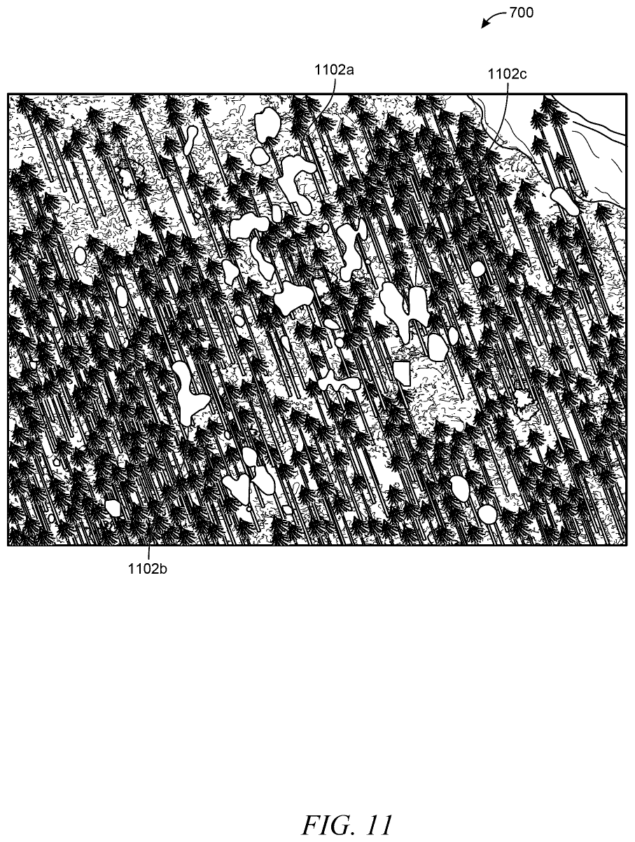

FIG. 11 depicts polygons representing hazard trees superimposed on the image 700 of FIG. 7 that may be generated by the hazard tree identification system 104 in some embodiments. The polygons include a first polygon 1102a, a second polygon 1102b, and a third polygon 1102c. Each of the polygons 1102 corresponds to or represents one or more hazard trees in the image 700. It will be appreciated that the first polygon 1102a corresponds to or represents the first collection 1002a of FIG. 10, and that the second polygon 1102b corresponds to or represents the second collection 1002b and the third polygon 1102c corresponds to or represents the third collection 1002c, both also of FIG. 10. The hazard tree identification system 104 has generated the polygons 1102 based on the collections 1002.

Returning to FIG. 5, also at step 506, the hazard tree identification system 104 (for example, the polygon attributes module 212) may determine or identify metrics for the multiple polygons. For example, for a polygon, the hazard tree identification system 104 may determine a two-dimension area of the polygon using the set of coordinates that define the polygon. The hazard tree identification system 104 may also apply a statistical function to the probabilities of the pixels of the polygon to determine a value. For example, the hazard tree identification system 104 may average the probabilities of the pixels of the polygon to determine an average probability (a mean probability) for the polygon. The hazard tree identification system 104 may also assign one or more unique identifiers to the polygon.

In various embodiments, after the hazard tree identification system 104 has digitized hazard trees, at step 518 one or more quality checks may be performed to remove false positives and correct false negatives. The performance of a quality check may include a person reviewing representations of classification data structures and images received at step 502 in some embodiments. In various embodiments, the hazard tree identification system 104 may perform the quality check by, for example, comparing classification data structures with ground truth determinations of hazard trees to ensure that the numbers or percentages of false positives and the numbers or percentages of false negatives are within appropriate ranges and/or do not meet or exceed appropriate values.

At step 508 the hazard tree identification system 104 (for example, the polygon attributes module 212) may receive the multiple polygons generated at step 506. At step 510 the hazard tree identification system 104 (for example, the polygon attributes module 212) may determine heights of polygons. In some embodiments, the hazard tree identification system 104 may utilize one or more canopy height models (CHMs) to determine the heights of the polygons. The hazard tree identification system 104 may generate the one or more CHMs using the techniques described in the above-referenced U.S. patent application Ser. No. 18/167,830. Additionally or alternatively, the hazard tree identification system 104 may obtain the one or more CHMs from one or more of the data sources 102.

For a polygon corresponding to or representing one or more hazard trees, the hazard tree identification system 104 may utilize the one or more CHMs to determine a height for each pixel of the polygon. The hazard tree identification system 104 may then determine one or more metrics for the polygon based upon the heights of each pixel encompassed by the polygon. For example, the hazard tree identification system 104 may determine an average (mean), a 50th percentile, an 85th percentile, a 90th percentile, a 95th percentile, and/or the like. The hazard tree identification system 104 may assign one or more of the metrics to the polygon as one or more heights of the polygon.

In various embodiments, the hazard tree identification system 104 (for example, the polygon attributes module 212) may filter out polygons whose height do not meet or exceed a height threshold value. The hazard tree identification system 104 may filter out such polygons because the corresponding hazard trees are considered to be not tall enough to be a potential hazard to electrical assets. In some embodiments, the hazard tree identification system 104 does not filter out polygons based on heights.

Also at step 510, for a polygon, the hazard tree identification system 104 (for example, the polygon attributes module 212) may determine one or more distances between the polygon and one or more electrical assets of the power distribution infrastructures. For example, the hazard tree identification system 104 may determine a distance between each pixel of the polygon and each pixel of each electrical asset proximate to the polygon. The hazard tree identification system 104 may utilize bounding boxes around an electrical asset to determine which polygons are proximate to the electrical asset and only determine distances to the electrical asset for those polygons. For example, the hazard tree identification system 104 may utilize bounding boxes that have borders that are approximately 150 feet from the electrical asset to determine which polygons are proximate to the electrical asset. The hazard tree identification system 104 may determine multiple distances from the polygon to an electrical asset.

Also at step 510, the hazard tree identification system 104 (for example, the potential hazard identification module 218) may determine one or more obstructions (for example, trees or buildings) between hazard trees and electrical assets. The hazard tree identification system 104 may also determine site factors (for example, the slopes of the ground on which hazard trees are situated, soil types, or load factors such as vines or moss) for hazard trees. The hazard tree identification system 104 may also determine tree features such as whether the hazard tree is leaning and the size of the hazard tree (for example, the diameter at breast height (DBH) of the trunk of the hazard tree).

Also at step 510, the hazard tree identification system 104 (for example, the potential hazard identification module 218) may, for the electrical asset, determine whether or not the one or more hazard trees are a potential hazard to the electrical asset. The hazard tree identification system 104 may utilize a height of the polygon (for example, the mean height of the pixels of the polygon) and a distance from the polygon to the electrical asset (for example, the shortest horizontal distance from the polygon to the electrical asset), one or more obstructions, site factors, or tree features. The hazard tree identification system 104 may also, for the electrical asset, determine a risk posed to the electrical asset by one or more hazard trees corresponding to or represented by the polygon that the hazard tree identification system 104 has determined is proximate to the electrical asset. For example, the hazard tree identification system 104 may determine an amount of or an extent of the risk that the one or more hazard trees may fall into the electrical asset. In some embodiments, the hazard tree identification system 104 determines whether a hazard tree is a striking risk or a non-striking risk to electrical assets, and classifies hazard trees as striking risks or non-striking risks. In some embodiments, the hazard tree identification system 104 classifies the particular electrical asset as at one of low risk, medium risk, and high risk based on various metrics of the one or more hazard trees.

Also at step 510, the hazard tree identification system 104 may determine a prioritization of an electrical asset based on the identifications of the hazard trees that are proximate to the electrical asset. In some embodiments, the hazard tree identification system 104 may determine a risk score for each electrical asset based on various factors, such as the number of hazard trees proximate to the electrical asset, the amount or extent of risk the hazard trees pose to the electrical asset or the classifications of the hazard trees (for example, striking risk, non-striking risk), the time since vegetation management was last performed on vegetation near the electrical asset, a grow-in risk of vegetation proximate to the electrical asset, or other factors. In some embodiments, based on the risk score (which may be in the range from 0 to 1, for example), the hazard tree identification system 104 may assign a prioritization label to the electrical asset, such as either low, medium, high, or critical. For electrical assets for which the hazard tree identification system 104 may not be able to determine a risk score, the hazard tree identification system 104 may assign a prioritization label of none to the electrical assets.

The risk score or the prioritization for electrical assets may be utilized for various purposes. For example, the hazard tree identification system 104 may generate and provide user interfaces that display the risk scores or the prioritizations for multiple electrical assets. The electrical assets may be colored differently based on their risk scores or prioritizations, or icons or other user interface elements associated with the electrical assets may be colored differently based on their risk scores or prioritizations. The user interfaces may also highlight or otherwise emphasize multiple electrical assets that have similar risk scores or prioritizations. For example, multiple electrical assets that have medium, high, or critical prioritizations may be highlighted as a hotspot of hazard trees in the user interfaces.

In various embodiments, the hazard tree identification system 104 may utilize the following method to determine an amount or extent of a risk to an electrical asset posed by a hazard tree. The hazard tree identification system 104 may calculate a radial distance from the tree to the electrical asset using a horizontal distance from the hazard tree to the electrical asset and a height of the hazard tree. The hazard tree identification system 104 may utilize the height of the tallest pixel of the hazard tree as the height of the hazard tree. If the hazard tree identification system 104 determines that the radial distance is smaller than the height of the hazard tree, then the hazard tree identification system 104 may determine that the hazard tree poses a high fall-in risk to the electrical asset. In such a case, the hazard tree identification system 104 classifies the electrical asset as at high risk. An example of a fall-in risk is that the hazard tree may fall into or onto the electrical asset, such as during or after a storm.

If the hazard tree identification system 104 determines that there are no hazard trees whose radial distances are smaller than their heights, the hazard tree identification system 104 may determine that any hazard trees that are still within a predetermined zone surrounding or bounding the electrical asset pose a medium fall-in risk to the electrical asset. In such cases, the hazard tree identification system 104 may classify the electrical asset as at medium risk. For example, the hazard tree identification system 104 may classify a span as at medium risk if there is at least one hazard tree within a 150 foot zone on either side of the span.

If there are no hazard trees within the predetermined zone surrounding or bounding the electrical asset, the hazard tree identification system 104 may classify the electrical asset as at low risk. It should be noted that an electrical asset may have its risk classification changed or modified based on other factors, such as proximity to healthy trees or length in time from last trim cycle.

The hazard tree identification system 104 may utilize one or more heights of the one or more hazard trees, one or more distances to the electrical asset, a number of the one or more hazard trees, and/or other metrics to classify the risk to the electrical asset. For example, the hazard tree identification system 104 may classify the electrical asset as at low risk if there are no hazard trees whose heights are greater than the distances from the hazard trees to the electrical asset. As another example, the hazard tree identification system 104 may classify the electrical asset as at medium risk if there is only one hazard tree whose height is greater than the distance from the hazard tree to the electrical asset. As another example, the hazard tree identification system 104 may classify the electrical asset as at high risk if there is more than one hazard tree whose heights are greater than the distances from the hazard trees to the electrical asset.

In some embodiments, the hazard tree identification system 104 may utilize other metrics as an alternative to or in addition to heights and distances to determine risks and/or classify risks posed by one or more hazard trees to an electrical asset. The various metrics may include an area of a polygon corresponding to one or more hazard trees, a mean probability of the pixels classified as hazard tree pixels of the polygon, and a height of the highest pixel of the polygon. It will be appreciated that the hazard tree identification system 104 may utilize various metrics and/or various methods to determine risks and/or classify risks.

In some embodiments, the hazard tree identification system 104 evaluates obstructions along potential fall paths between a tree and the wire. Obstructions include other trees and buildings, each of which may be modeled to cast a “shadow” on the wire based on their relative geometry. Shadowed wire segments are classified as protected because a falling tree would strike the obstruction first, while “unshadowed” segments are treated as potentially hazardous. Obstruction severity is further quantified using the number of obstructions and their collective width along the projected fall path, preventing small or mis-detected obstructions from disproportionately reducing risk. A probabilistic function, such as an exponential decay model based on obstruction count and obstruction length, is used to estimate obstruction-related fall probability.

The hazard tree identification system 104 also evaluates site factors, including the slope of the ground between the tree and the wire. Using digital terrain models (DTMs), the hazard tree identification system 104 calculates a slope metric based on elevation differences and horizontal distance. Positive slope values indicate the wire lies downslope from the tree, increasing the likelihood that gravitational fall motion would carry the tree toward the wire. Conversely, negative slopes indicate the wire lies upslope and present reduced likelihood of contact. The hazard tree identification system 104 assigns a slope-based risk probability using a classified slope-range table and a logistic function, with specific ranges corresponding to “very high,” “high,” “medium,” “low,” or “negligible” fall risk. The model includes caveats for cases involving terrain depressions or valleys, where simple slope metrics may misrepresent true fall direction.

Furthermore, the hazard tree identification system 104 incorporates tree-specific characteristics, including tree height, lean, diameter/size, structural load factors (such as attached vines), and positional asymmetries that may render some trees non-actionable. The model integrates all factors-obstructions, slope, and tree attributes-into an overall fall-risk computation, enabling determination of whether a tree within striking range of infrastructure is actionable. This integrated probability may be computed as a composite function combining the obstruction risk, slope-derived risk, and height-differential considerations.

In some embodiments, the hazard tree identification system 104 utilizes the following factors to determine whether a hazard tree poses an actionable risk: obstructions such as other trees or buildings, site factors such as the slope of the ground on which the tree is lying, the soil type, and a load factor (vine, mosses, etc.) and tree features, such as lean, size of the tree, and height of the tree. The hazard tree identification system 104 may determine an actionable risk probability value for obstructions, site factors, and tree features and determine a total actionable risk probability value based on the actionable risk probability value. The hazard tree identification system 104 may utilize the following equation (5)

$${P}_{total} = 1 - ( 1 - {P}_{obs} ) ( 1 - {P}_{slope} ) ( 1 - {P}_{h d} ) \qquad ( 5 )$$

As an example, for obstructions, the hazard tree identification system 104 may determine that an actionable risk probability value is extremely high where there are zero obstructions, high where there is one obstruction, exceedingly small where there are two obstructions, and close to zero where there are three or more obstructions.

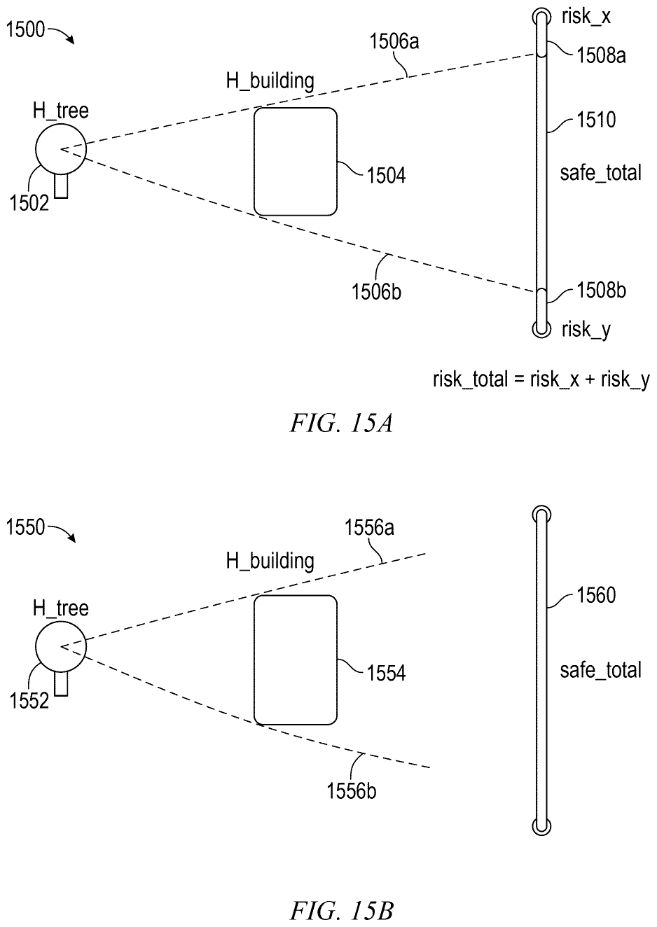

The hazard tree identification system 104 may utilize a top-view geometric model to project potential tree fall directions from a hazard tree toward nearby wires. For example, obstructions (trees, buildings) create a shadow on the wire: Shadowed segments are safe (tree hits obstruction first), whereas unshadowed segments are risky (tree can fall around edges and strike the wire). The hazard tree identification system 104 may perform a height comparison and use the height comparison (H_tree vs H_building) to assess risk: If H_tree≤H_building, no actionable risk exists, whereas if H_tree>H_building, only unshadowed wire segments are actionable. Safe vs risk area alone is insufficient because a single obstruction may consist mostly of branches that a falling tree can pass through. The hazard tree identification system 104 may account for obstruction density using a number of obstructions (n) between the tree and the wire and a total obstruction width (L) along the fall path. This prevents small or mis-detected trees from disproportionately reducing risk while penalizing multiple substantial obstructions. FIGS. 15A and 15B depict example potential tree fall directions from hazard trees toward electrical wires according to some embodiments. FIG. 15A depicts that a tree 1502 may fall on either side of a building 1504 on a first path 1506a which may strike a first portion 1508a of a wire 1510 or on a second path 1506b which may strike a second portion 1508b of the wire 1510. In such a scenario, the total risk may be a function of a risk of striking the first portion 1508a and a risk of striking the second portion 1508b. FIG. 15B depicts that a tree 1552 may fall on either side of a building 1554 on a first path 1556a on a second path 1556b but may not strike the wire 1560.

The hazard tree identification system 104 may utilize a probability function to determine an obstruction risk. For example, the hazard tree identification system 104 may utilize the probability function in the following equation (6):

$$P ( n , L ) = {e}^{( - 0.1 * L * \sqrt{n} )} \qquad ( 6 )$$

In equation (6), L may be the total obstruction width along the fall path and n may be the number of obstructions between the tree and the wire.

The hazard tree identification system 104 may use DTM data determine a slope and whether a wire is upslope or downslope from a tree. For example, the hazard tree identification system 104 may use the following equation (7):

$$S t = arc tan ( \frac{{H}_{tree} - {H}_{wire}}{d} ) \qquad ( 7 )$$

In equation (7), Hₜᵣₑₑ may be the highest (or 98^{th} percentile) elevation where the tree is and H_{wire} may be the lowest (or 2^{nd} percentile) elevation where the wire is and d may be the horizontal distance of the tree from the wire. If St>0 then the hazard tree identification system 104 may determine that the wire is downslope from the tree (the ground is sloping toward the wire). If St<0 then the hazard tree identification system 104 may determine that the wire is upslope from the tree (the ground is sloping away from the wire). The hazard tree identification system 104 may utilize the probability function in the following equation (8):

$$P ( s t = x ) = \frac{1}{( 1 + {e}^{( - 17.3 ( x + 0.105 ) )} )} \qquad ( 8 )$$

The hazard tree identification system 104 may utilize the following table to determine a P_slope:

| Sts_tst(radians) | | | |
|---|---|---|---|
| range | Ground condition | Qualitative risk | P_slope |
| st ≥ 0.349 | Very steep toward | Extremely high | 1.0 |
| | wire | | |
| 0.175 ≤ st < 0.349 | Steep toward wire | High | 0.95 |
| +0.035 ≤ st < +0.175 | Mild toward wire | Medium | 0.90 |
| −0.035 < st < +0.035 | Nearly flat | Low | 0.85 |
| −0.175 ≤ st ≤ −0.035 | Mild slope away | Extremely low | 0.50 |
| st < −0.175 | Steep away from | Close to zero | 0.20 |
| | wire | | |

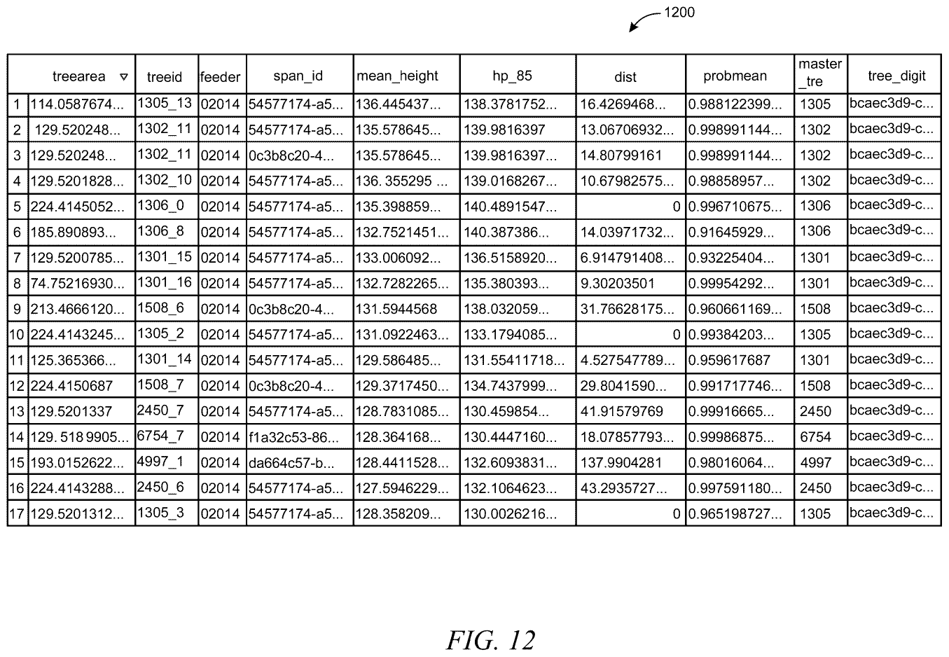

The hazard tree identification system 104 may, at step 512, determine, identify, collect, and/or generate one or more metrics as an output for the hazard trees that the hazard tree identification system 104 has identified. FIG. 12 depicts a table 1200 that the hazard tree identification system 104 has generated in some embodiments. The table 1200 contains metrics for hazard trees that the hazard tree identification system 104 has identified. The metrics may include, for each hazard tree, an area of the hazard tree, a unique identifier of the hazard tree, a unique identifier of a feeder of which an electrical asset is a part, a unique identifier of an electrical asset (for example, a span) to which the hazard tree poses a risk, a mean height of the hazard tree, and an 85th percentile height of the hazard tree. The metrics may also include a distance from the hazard tree to the electrical asset, and a mean probability of the pixels of the hazard tree. The hazard tree identification system 104 may determine, identify, collect, and/or generate one or more metrics other than those disclosed herein for the hazard trees.

Returning to FIG. 5, at step 514, the hazard tree identification system 104 may store the output, such as in the data storage 224. At step 516 the hazard tree identification system 104 (for example, the notification module 222) may generate one or more notifications of the potential hazards posed by one or more hazard trees to one or more electrical assets and provide the one or more notifications. For example, the hazard tree identification system 104 may provide the one or more notifications to an infrastructure system 106. In various embodiments, the hazard tree identification system 104 provides the table 1200 of FIG. 12 as a notification.

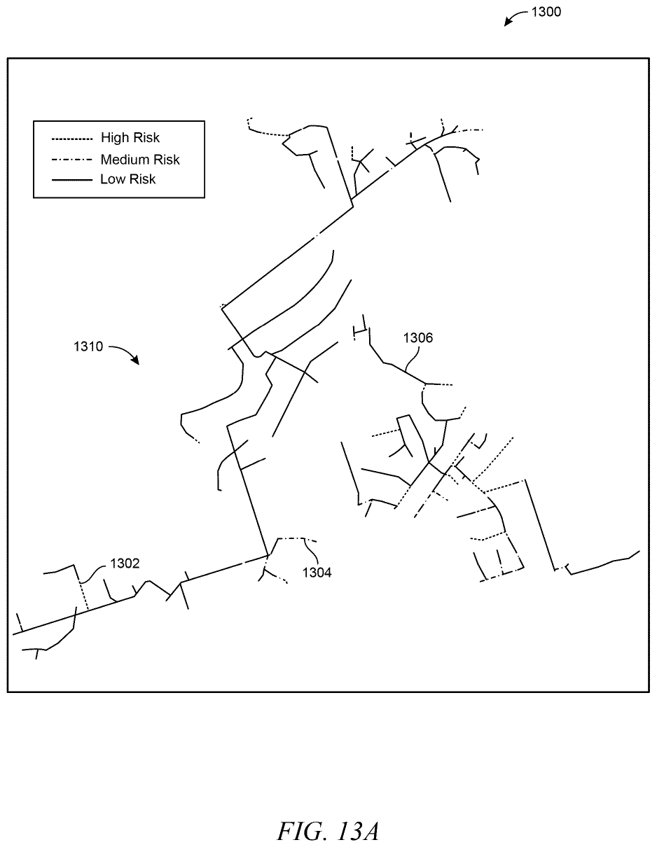

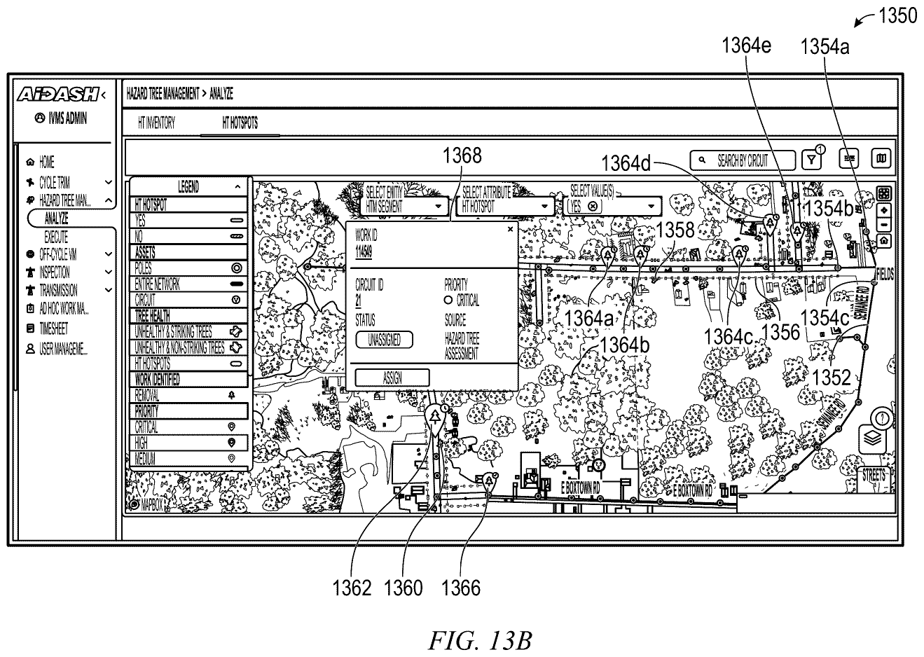

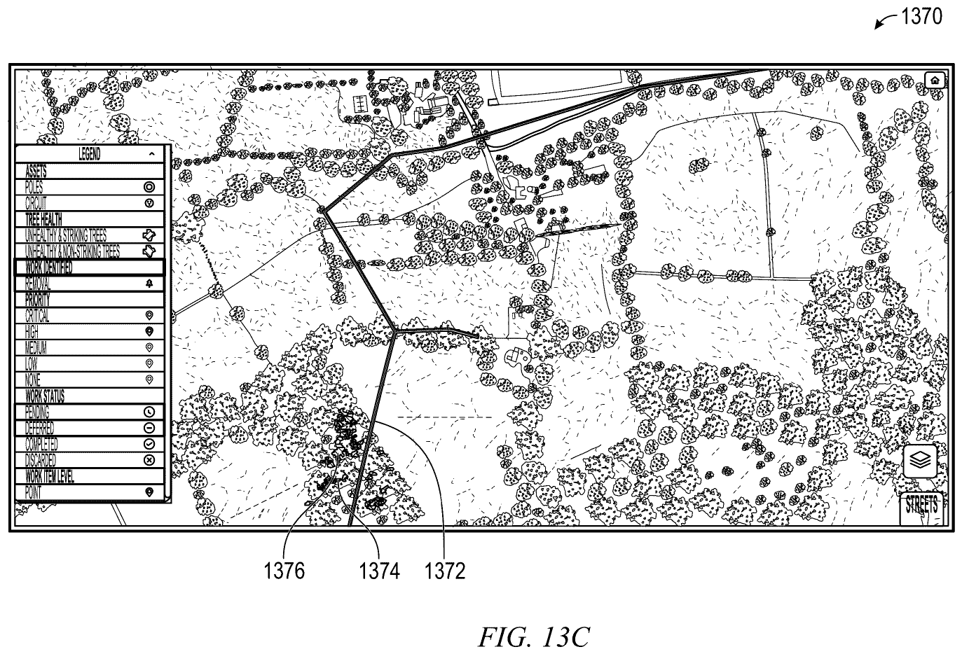

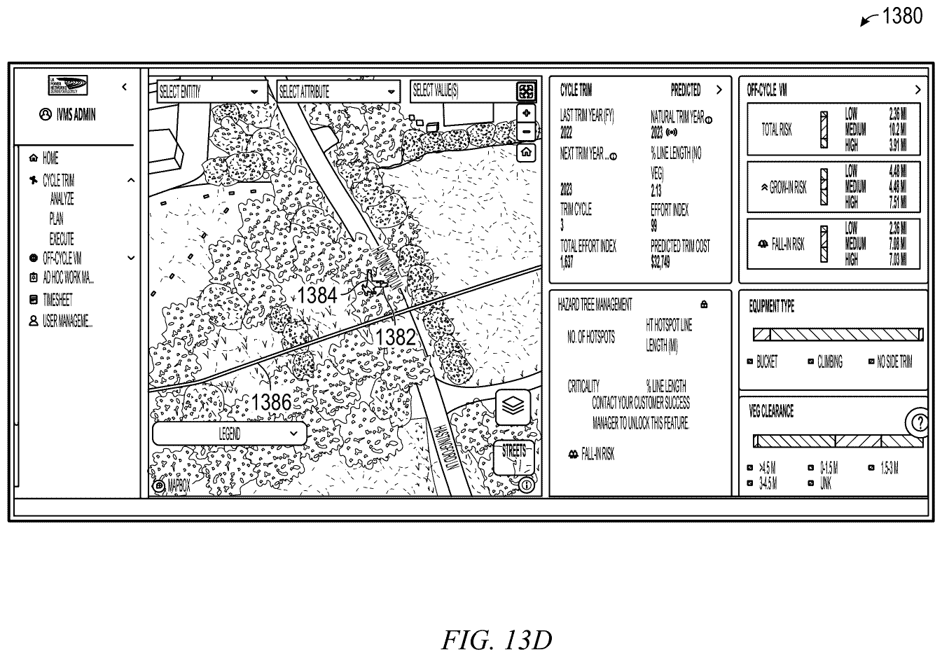

In some embodiments, the hazard tree identification system 104 (for example, the user interface module 220) generates a user interface that includes one or more electrical assets and one or more indications of one or more risks to the one or more electrical assets. FIG. 13A depicts an example user interface 1300 that the hazard tree identification system 104 may generate in some embodiments. The user interface 1300 includes a representation 1310 of a power distribution infrastructure containing multiple electrical assets-spans. The hazard tree identification system 104 has classified the multiple spans according to the risks posed by one or more hazard trees identified by the hazard tree identification system 104. The hazard tree identification system 104 has classified a span 1302 as at high risk from one or more hazard trees proximate to the span 1302. The hazard tree identification system 104 has classified a span 1304 as at medium risk from one or more hazard trees proximate to the span 1304. The hazard tree identification system 104 has classified a span 1306 as at low risk from one or more hazard trees proximate to the span 1306. The hazard tree identification system 104 may color-code the spans according to their classifications. For example, a span may be colored red if it is classified as at high risk, blue if it is classified as at medium risk, and green if it is classified as at low risk.

The hazard tree identification system 104 may provide the user interface 1300 as part of providing a notification of potential hazards to electrical assets. The hazard tree identification system 104 may provide the user interface 1300 in conjunction with a map view that allows for scrolling, zooming, adding and removing overlays, and other common map view functions. The user interface 1300 may allow a user to select a span. In response to receiving a selection of a span, the hazard tree identification system 104 may show the one or more hazard trees that represent a potential hazard to the selected span and details about the one or more hazard trees, such as height, area, species, volume, or other metrics. The hazard tree identification system 104 may also provide information about when the vegetation management operations were last performed about the selected span. In some embodiments, the hazard tree identification system 104 may allow a user to commence and submit a work order for vegetation management operations for the selected span. In various embodiments, the hazard tree identification system 104 may automatically submit work orders for trimming operations for high-risk spans or other high-risk electrical assets.

In some embodiments, the hazard tree identification system 104 may generate a shapefile that includes identifications of hazard trees, detection probabilities, heights, and/or other metrics. The hazard tree identification system 104 may provide the shapefile to the infrastructure system 106 so that the shapefile may be used by Geographic Information System (GIS) programs that the utility operating the infrastructure system 106 utilizes.

Returning to FIG. 5, in various embodiments, field validation of the identification of hazard trees by the hazard tree identification system 104 may be performed at step 520. For example, an employee of a utility may confirm in the field that a tree identified as a hazard by the hazard tree identification system 104 is indeed a hazard and that it poses a risk to an electrical asset. The field validation may be recorded at step 522 and the hazard tree identification system 104 may store the field validation at step 514 in, for example, the data storage 224. The hazard tree identification system 104 may utilize the field validation to assist in future training of the one or more AI and/or ML models. One advantage of utilizing field validations may be in the reduction of future false positives and/or false negatives by the hazard tree identification system 104.

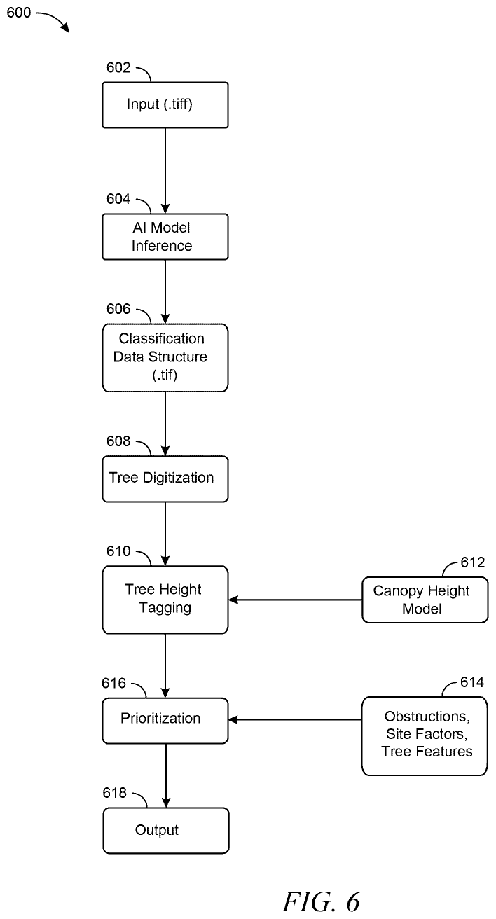

FIG. 6 is a diagram depicting a method 600 for identifying hazard trees in some embodiments. The hazard tree identification system 104 (for example, various modules of the hazard tree identification system 104) may perform the method 600. The method 600 may begin at step 602 where the hazard tree identification system 104 (for example, the data retrieval and processing module 204) receives images for a geographic area. The hazard tree identification system 104 may process the images as described in step 502 of the method 500, or the images may have already been processed as described in step 502 of the method 500, such as by a different system. At step 604 the hazard tree identification system 104 (for example, the model inference module 208) may perform inference using the images received in step 602. At step 606 the hazard tree identification system 104 may generate a representation of a classification data structure.

At step 608 the hazard tree identification system 104 may digitize hazard trees using the classification data structure. The hazard tree identification system 104 may generate a shapefile that includes polygons representing hazard trees and probability attributes for the polygons. The shapefile may encompass all or a portion of the geographic area for the images received in step 602. At step 610 the hazard tree identification system 104 may assign heights to hazard trees using one or more canopy height models 612. Also at step 610 the hazard tree identification system 104 may determine distances between hazard trees and electrical assets. The hazard tree identification system 104 may also determine whether or not hazard trees represent potential hazards to the electrical assets based on the heights and distances.

At step 616 the hazard tree identification system 104 may determine a prioritization for electrical assets risk score or prioritization using obstruction, site factors (for example, slope), and tree features data 614. In some embodiments, the hazard tree identification system 104 may also, at step 616, determine a prioritization label based on the risk score (for example, prioritization labels may be none, low, medium, high, or critical).

At step 618 the hazard tree identification system 104 may generate and provide an output. In various embodiments, the output includes a shapefile with identifications of hazard trees, detection probabilities, heights, and/or other metrics. In some embodiments, the hazard tree identification system 104 may generate a table similar to the table 1200 depicted in FIG. 12 and/or a user interface similar to the user interface 1300 depicted in FIG. 13A as the output. The hazard tree identification system 104 may provide the output to, for example, an infrastructure system 106.

FIG. 13B depicts another example user interface 1350 that the hazard tree identification system 104 may generate and provide in some embodiments. The user interface 1350 depicts a satellite view of a geographic area overlaid with electrical asset data and hazard tree data. The electrical assets include a span 1352 and multiple poles 1354 (shown individually as pole 1354a, pole 1354b, and pole 1354c) A portion 1356 of the span 1352 is shown as emphasized (for example, in red) to indicate that there are one or more hazard trees proximate to the portion 1356, and that the portion 1356 is considered to be a hazard tree hotspot. The hazard tree identification system 104 has determined that a first hazard tree 1358 is a non-striking tree, meaning that the hazard tree identification system 104 has determined that there is a low probability of the first hazard tree 1358 striking the span 1352. The hazard tree identification system 104 has determined that a second hazard tree 1360 is a striking tree, meaning that the hazard tree identification system 104 has determined that there is a high probability of the second hazard tree 1360 striking the span 1352.

The hazard tree identification system 104 has also assigned a pole of the span 1352, as indicated by first icon 1366, as having a medium priority based on the proximity of one or more hazard trees, and multiple portions of the span 1352 (as indicated individually as second icon 1364a, second icon 1364b, second icon 1364c, second icon 1364d, and second icon 1364e) as high priority based on the proximity of one or more hazard trees. The hazard tree identification system 104 has also assigned another portion of the span 1352, as indicated by third icon 1362, as having a critical priority based on the proximity of one or more hazard trees. Upon selection of the third icon 1362, the hazard tree identification system 104 displays an overlay 1368 that displays information about the other portion of the span 1352, such as the identifier of the corresponding circuit, the priority, the source of the priority determination (for example, the proximity of one or more hazard trees), and the identifier of a work order that has been created to perform vegetation management on the one or more hazard trees. The overlay 1368 may also allow a user to assign the work order, such as to a vegetation management contractor. Other details may also be provided in the overlay 1368.

The user interface 1350 may also include information for electrical assets as to whether work orders have been created or assigned to perform vegetation management on the one or more hazard trees that are proximate to the electrical assets. For example, the third icon 1362 may include a clock element to indicate that a work order has been created but not yet assigned, and the second icons 1364 may include similar clock elements. The first icon 1366 may include a checkbox element to indicate that a work order has been created and assigned, such as to a vegetation management contractor.

FIG. 13C depicts another example user interface 1370 that the hazard tree identification system 104 may generate and provide in some embodiments. The user interface 1370 depicts a satellite view of a geographic area overlaid with electrical asset data and hazard tree data. The electrical assets include a span 1372. The hazard tree identification system 104 has determined that a first hazard tree 1376 is a non-striking tree and that a second hazard tree 1374 is a striking tree.

FIG. 13D depicts another example user interface 1380 that the hazard tree identification system 104 may generate and provide in some embodiments. The user interface 1380 depicts a satellite view of a geographic area overlaid with electrical asset data and hazard tree data. The electrical assets include a span 1386. The hazard tree identification system 104 has determined that a first hazard tree 1384 is a non-striking tree and that a second hazard tree 1382 is a striking tree. The user interface 1380 also displays information about vegetation management for the span 1386, such as information about a trim cycle for the span 1386 and off-cycle vegetation management information. The off-cycle vegetation management information may include bar charts for parts of the span 1386 that are at low, medium, and high risk, for fall-in risk, grow-in risk, and total risk. The user interface 1380 also displays information about the types of equipment predicted to be utilized for vegetation management proximate to the span 1386 and information about vegetation clearance for the span 1386.

The hazard tree identification system 104 may generate and provide user interfaces that include additional details or aspects that indicate suggested prioritization or risk scores of electrical assets. For example, the hazard tree identification system 104 may emphasize certain electrical assets (for example, certain spans) in one color (for example, red) that are considered to be hazard tree hotspots (due to the proximity of one or more hazard trees) and other electrical assets (for example, other spans) in another color (for example, green) that are considered to not be hazard tree hotspots. As another example, hazard tree identification system 104 may color certain polygons as one color (for example, yellow) for hazard trees that are considered as non-striking and other polygons as another color (for example, red) for hazard trees that are considered as striking. The hazard tree identification system 104 may color certain electrical assets (for example, spans) as one color (for example, green) where there are no hazard trees proximate to the electrical assets, certain electrical assets as another color (for example, yellow) where there are non-striking hazard trees proximate to the electrical assets, and certain electrical assets as another color (for example, red) where there are striking hazard trees proximate to the electrical assets. The hazard tree identification system 104 may also apply labels to the electrical assets, such as “No Hazard Trees,” “Striking Hazard Trees,” and “Non-Striking Hazard Trees.” In some embodiments, the hazard tree identification system 104 may use the term “unhealthy trees” to refer to “hazard trees.” Other variations are possible.

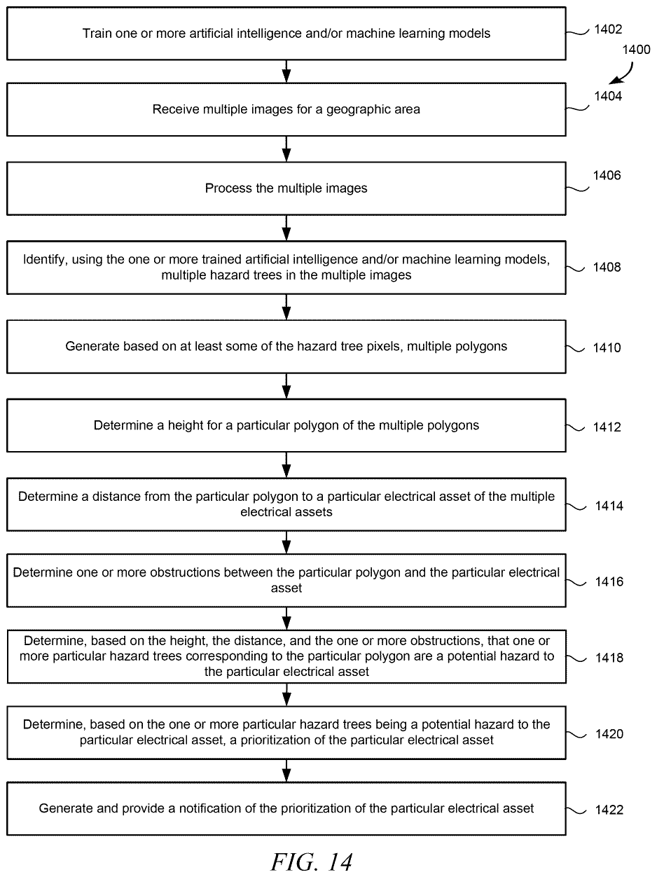

FIG. 14 is a flow diagram depicting a method 1400 for identifying hazard trees in some embodiments. The hazard tree identification system 104 (for example, various modules of the hazard tree identification system 104) may perform the method 1400. The method 1400 may begin at step 1402 where the hazard tree identification system 104 (for example, the model training module 206) may train one or more artificial intelligence and/or machine learning models. For example, the hazard tree identification system 104 may train one or more fully convolutional neural networks and/or convolutional neural networks as described herein.

At step 1404 the hazard tree identification system 104 (for example, the data retrieval and processing module 204) receives multiple images for a geographic area. The geographic area includes multiple electrical assets of a power distribution infrastructure (for example, spans, poles, transformers) of an electrical power utility. At step 1406 the hazard tree identification system 104 (for example, the data retrieval and processing module 204) may process the multiple images. For example, the hazard tree identification system 104 may normalize the intensity values of each pixel of each image of the multiple images (for example, to be a value between zero (0) and one (1)). The hazard tree identification system 104 may process the multiple images using other techniques, such as those described herein.

At step 1408 the hazard tree identification system 104 (for example, the model inference module 208) identifies, using the one or more trained artificial intelligence and/or machine learning models, multiple hazard trees in the multiple images. The hazard tree identification system 104 may identify hazard trees using the techniques described herein (for example, classifying pixels of images as hazard tree pixels or as non-hazard tree pixels and digitizing hazard trees based on the hazard tree pixels).

At step 1410, the hazard tree identification system 104 (for example, the polygon attributes module 212) may generate based on at least some of the hazard tree pixels, multiple polygons. A polygon of the multiple polygons may correspond to one or more hazard trees in the geographic area. At step 1412 the hazard tree identification system 104 (for example, the module 212) may determine a height for a particular polygon of the multiple polygons. For example, the hazard tree identification system 104 may use one or more canopy height models (CHMs) to determine the at least one height of the at least one hazard tree. At step 1414 the hazard tree identification system 104 (for example, the polygon attributes module 212) may determine a distance between the particular polygon and at least one electrical asset of the multiple electrical assets. The hazard tree identification system 104 may determine the at least one distance as described herein. At step 1416 the hazard tree identification system 104 (for example, the module 212) may determine one or more obstructions (for example, buildings or other trees.) between the particular polygon and the particular electrical asset.

At step 1418 the hazard tree identification system 104 (for example, the potential hazard identification module 218) may determine, based on the height, the distance, and the one or more obstructions, that one or more particular hazard trees corresponding to the particular polygon are a potential hazard to the particular electrical asset. At step 1420 the hazard tree identification system 104 (for example, the potential hazard identification module 218) may determine, based on the one or more particular hazard trees being a potential hazard to the particular electrical asset, a prioritization of the particular electrical asset. The hazard tree identification system 104 may determine the prioritization as described herein.

At step 1422 the hazard tree identification system 104 (for example, the notification module 222) may, for the at least one hazard tree, generate a notification of the prioritization of the particular electrical asset and provide the notification. The hazard tree identification system 104 may generate and provide the notification as described herein.

One advantage of embodiments of the hazard tree identification system 104 and associated methods and non-transitory computer-readable media is that the hazard tree identification system 104 is able to predict patterns of hazard trees across large numbers of images that include electrical assets. Another advantage is that the hazard tree identification system 104 may minimize or reduce the amount of manual work that would otherwise be done to detect hazard trees. Images such as satellite images may be acquired frequently. The hazard tree identification system 104 may process such images as they are acquired and identify new hazard trees and/or stop tracking hazard trees as they are removed. Accordingly, the hazard tree identification system 104 may facilitate monitoring of a power distribution infrastructure on a periodic and/or as-needed basis.

FIG. 16 depicts a block diagram of an example digital device 1600 according to some embodiments. The digital device 1600 is shown in the form of a general-purpose computing device. The digital device 1600 includes at least one processor 1602, which may be or include one or more central processing units (CPUs) or one or more graphics processing units (GPUs), random access memory (RAM 1604), communication interface 1606, input/output device 1608, storage 1610, and a system bus 1612 that couples various system components including storage 1610 to the at least one processor 1602. A set (which may be a physical set or a logical set) of one or more of the digital device 1600 may be referred to as a computing system.

System bus 1612 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1600 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1602 is configured to execute executable instructions (for example, programs). In some embodiments, the at least one processor 1602 comprises circuitry or any processor capable of processing the executable instructions.

In some embodiments, RAM 1604 stores programs or data. In various embodiments, working data is stored within RAM 1604. The data within RAM 1604 may be cleared or ultimately transferred to storage 1610, such as prior to reset or powering down the digital device 1600.

In some embodiments, the digital device 1600 is coupled to a network via communication interface 1606. The digital device 1600 can communicate with one or more networks such as a local area network (LAN), a general wide area network (WAN), or a public network (for example, the Internet).

In some embodiments, input/output device 1608 is any device that inputs data (for example, mouse, keyboard, stylus, sensors, etc.) or outputs data (for example, speaker, display, virtual reality headset).

In some embodiments, storage 1610 can include computer system readable media in the form of non-volatile memory, such as read only memory (ROM), programmable read only memory (PROM), solid-state drives (SSD), flash memory, or cache memory. Storage 1610 may further include other removable/non-removable, volatile/non-volatile computer system storage media. By way of example only, storage 1610 can be provided for reading from and writing to a non-removable, non-volatile magnetic media. The storage 1610 may include a non-transitory computer-readable medium, or multiple non-transitory computer-readable media, which stores programs or applications for performing functions such as those described herein. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1612 by one or more data media interfaces. As will be further depicted and described below, storage 1610 may include at least one program product having a set (for example, at least one) of program modules that are configured to carry out the functions of embodiments of the technology. In some embodiments, RAM 1604 is found within storage 1610.

Programs/utilities, having a set (at least one) of program modules may be stored in storage 1610 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technology as described herein.

It should be understood that although not shown, other hardware or software components could be used in conjunction with the digital device 1600. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technology may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technology may be described with reference to flowchart illustrations or block diagrams of methods, apparatus (systems) and computer program products according to embodiments of the technology. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are only examples, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings. Accordingly, technologies described under a particular heading are not limited to the concepts or features described under that particular heading.

It may be apparent that various modifications may be made, and other embodiments may be used without departing from the broader scope of the discussion herein. For example, although determining potential hazards to electrical assets of electrical utilities and to assets (for example, pipelines) of other utilities (for example, natural gas distribution utilities) may be described, the systems and methods described herein may be applicable to determining potential hazards and/or risks to any structure (for example, antennas, buildings, roads, etc.) posed by hazard trees. Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving multiple images for a geographic area, the geographic area including multiple electrical assets of a power distribution infrastructure;
classifying, using one or more trained models, at least some pixels of each image of the multiple images as hazard tree pixels or as non-hazard tree pixels;
generating, based on at least some of the hazard tree pixels, multiple polygons, a polygon of the multiple polygons corresponding to one or more hazard trees in the geographic area;
determining a height for a particular polygon of the multiple polygons;
determining a distance from the particular polygon to a particular electrical asset of the multiple electrical assets;
determining one or more obstructions between the particular polygon and the particular electrical asset;
determining, based on the height, the distance, and the one or more obstructions, that one or more particular hazard trees corresponding to the particular polygon are a potential hazard to the particular electrical asset;
determining, based on the one or more particular hazard trees being a potential hazard to the particular electrical asset, a prioritization of the particular electrical asset;
generating a notification of the prioritization of the particular electrical asset; and
providing the notification of the prioritization of the particular electrical asset.

2. The non-transitory computer-readable medium of claim wherein the one or more obstructions include one or more trees or one or more buildings.

3. The non-transitory computer-readable medium of claim wherein determining that the one or more particular hazard trees are a potential hazard to the particular electrical asset includes determining that the one or more particular hazard trees are a striking hazard to the particular electrical asset.

4. The non-transitory computer-readable medium of claim wherein classifying, using the one or more trained models, at least some pixels of each image of the multiple images as the hazard tree pixels or as the non-hazard tree pixels includes:
generating multiple probability data structures by processing the multiple images using the one or more trained models, a probability data structure of the multiple probability data structures corresponding to an image of the multiple images and including, for each pixel of at least some pixels of the image, a probability value that indicates a probability that the pixel is a portion of the one or more hazard trees; and
generating multiple classification data structures based on the multiple probability data structures, a classification data structure corresponding to an image of the multiple images and including, for each pixel of at least some pixels of the image, a classification of the pixel as a hazard tree pixel or as a non-hazard tree pixel.

5. The non-transitory computer-readable medium of claim wherein generating the multiple classification data structures based on the multiple probability data structures includes, for each probability data structure of at least some of the multiple probability data structures:
for each probability value of at least some of the probability values in the probability data structure:
comparing the probability value to a threshold value;
if the probability value is equal to or greater than the threshold value, classifying the pixel corresponding to the probability value as a hazard tree pixel; and
if the probability value is less than the threshold value, classifying the pixel corresponding to the probability value as a non-hazard tree pixel; and
generating a classification data structure that includes, for each pixel of at least some pixels of the image, the classification of the pixel as a hazard tree pixel or as a non-hazard tree pixel.

6. The non-transitory computer-readable medium of claim wherein a pixel of an image of the multiple images has one or more intensity values, and the method further comprises normalizing the one or more intensity values of each pixel of at least some pixels of each image of the multiple images.

7. The non-transitory computer-readable medium of claim wherein generating the notification of the prioritization of the particular electrical asset includes generating a user interface that displays the prioritization of the particular electrical asset and providing the notification of the prioritization of the particular electrical asset includes providing the user interface.

8. The non-transitory computer-readable medium of claim wherein classifying, using the one or more trained models, at least some pixels of the multiple images as the hazard tree pixels or as the non-hazard tree pixels includes, for each image of the multiple images:
generating one or more transformed images by performing one or more transformations on the image;
processing, by the one or more trained models, the one or more transformed images to generate one or more intermediate values for each pixel of at least some pixels of the image; and
classifying, based on the one or more intermediate values, each pixel of at least some pixels of the image as a hazard tree pixel or as a non-hazard tree pixel.

9. The non-transitory computer-readable medium of claim wherein generating the one or more transformed images by performing the one or more transformations on the image includes performing one or more of a rotation of the image, a flip of the image, a resizing of the image, and an addition of noise to the image.

10. The non-transitory computer-readable medium of claim wherein classifying, based on the one or more intermediate values, each pixel of at least some pixels of the image as the hazard tree pixel or as the non-hazard tree pixel includes applying a statistical function to the one or more intermediate values of each pixel of at least some pixels of the image.

11. A method, comprising:
receiving multiple images for a geographic area, the geographic area including multiple electrical assets of a power distribution infrastructure;
classifying, using one or more trained models, at least some pixels of each image of the multiple images as hazard tree pixels or as non-hazard tree pixels;
generating, based on at least some of the hazard tree pixels, multiple polygons, a polygon of the multiple polygons corresponding to one or more hazard trees in the geographic area;
determining a height for a particular polygon of the multiple polygons;
determining a distance from the particular polygon to a particular electrical asset of the multiple electrical assets;
determining one or more obstructions between the particular polygon and the particular electrical asset;
determining, based on the height, the distance, and the one or more obstructions, that one or more particular hazard trees corresponding to the particular polygon are a potential hazard to the particular electrical asset;
determining, based on the one or more particular hazard trees being a potential hazard to the particular electrical asset, a prioritization of the particular electrical asset;
generating a notification of the prioritization of the particular electrical asset; and
providing the notification of the prioritization of the particular electrical asset.

12. The method of claim wherein the one or more obstructions include one or more trees or one or more buildings.

13. The method of claim wherein determining that the one or more particular hazard trees are a potential hazard to the particular electrical asset includes determining that the one or more particular hazard trees are a striking hazard to the particular electrical asset.

14. The method of claim wherein classifying, using the one or more trained models, at least some pixels of each image of the multiple images as the hazard tree pixels or as the non-hazard tree pixels includes:
generating multiple probability data structures by processing the multiple images using the one or more trained models, a probability data structure of the multiple probability data structures corresponding to an image of the multiple images and including, for each pixel of at least some pixels of the image, a probability value that indicates a probability that the pixel is a portion of the one or more hazard trees; and
generating multiple classification data structures based on the multiple probability data structures, a classification data structure corresponding to an image of the multiple images and including, for each pixel of at least some pixels of the image, a classification of the pixel as a hazard tree pixel or as a non-hazard tree pixel.

15. The method of claim wherein generating the multiple classification data structures based on the multiple probability data structures includes, for each probability data structure of at least some of the multiple probability data structures:
for each probability value of at least some of the probability values in the probability data structure:
comparing the probability value to a threshold value;
if the probability value is equal to or greater than the threshold value, classifying the pixel corresponding to the probability value as a hazard tree pixel; and
if the probability value is less than the threshold value, classifying the pixel corresponding to the probability value as a non-hazard tree pixel; and
generating a classification data structure that includes, for each pixel of at least some pixels of the image, the classification of the pixel as a hazard tree pixel or as a non-hazard tree pixel.

16. The method of claim wherein a pixel of an image of the multiple images has one or more intensity values, and the method further comprises normalizing the one or more intensity values of each pixel of at least some pixels of each image of the multiple images.

17. The method of claim wherein generating the notification of the prioritization of the particular electrical asset includes generating a user interface that displays the prioritization of the particular electrical asset and providing the notification of the prioritization of the particular electrical asset includes providing the user interface.

18. The method of claim wherein classifying, using the one or more trained models, at least some pixels of the multiple images as the hazard tree pixels or as the non-hazard tree pixels includes, for each image of the multiple images:
generating one or more transformed images by performing one or more transformations on the image;
processing, by the one or more trained models, the one or more transformed images to generate one or more intermediate values for each pixel of at least some pixels of the image; and
classifying, based on the one or more intermediate values, each pixel of at least some pixels of the image as a hazard tree pixel or as a non-hazard tree pixel.

19. The method of claim wherein generating the one or more transformed images by performing the one or more transformations on the image includes performing one or more of a rotation of the image, a flip of the image, a resizing of the image, and an addition of noise to the image.

20. A system comprising at least one processor and at least one memory including executable instructions that when executed by the at least one processor cause the system to:
receive multiple images for a geographic area, the geographic area including multiple electrical assets of a power distribution infrastructure;
classify, using one or more trained models, at least some pixels of each image of the multiple images as hazard tree pixels or as non-hazard tree pixels;
generate, based on at least some of the hazard tree pixels, multiple polygons, a polygon of the multiple polygons corresponding to one or more hazard trees in the geographic area;
determine a height for a particular polygon of the multiple polygons;
determine a distance from the particular polygon to a particular electrical asset of the multiple electrical assets;
determine one or more obstructions between the particular polygon and the particular electrical asset;
determine, based on the height, the distance, and the one or more obstructions, that one or more particular hazard trees corresponding to the particular polygon are a potential hazard to the particular electrical asset;
determine, based on the one or more particular hazard trees being a potential hazard to the particular electrical asset, a prioritization of the particular electrical asset;
generate a notification of the prioritization of the particular electrical asset; and
provide the notification of the prioritization of the particular electrical asset.
